(19) United States
(12) Patent Application Publication
(10) Pub. No.: US 2019/0371584 A1
(43) Pub. Date: Dec. 5, 2019

(54) BENCH-TOP TIME OF FLIGHT MASS SPECTROMETER

(71) Applicant: MICROMASS UK LIMITED, Wilmslow (GB)

(72) Inventors: Peter Carney, Dukinfield (GB); Haydn Murray, South Reddish (GB); Jason L. Wildgoose, Heaton Mersey (GB)

(21) Appl. No.: 16/428,151

(22) Filed: May 31, 2019

Related U.S. Application Data
(60) Provisional application No. 62/678,843, filed on May 31, 2018.

(51) Int. Cl. H01J 49/00; H01J 49/24; H01J 49/06; H01J 49/40

(52) U.S. Cl. CPC H01J 49/0013; H01J 49/40; H01J 49/067; H01J 49/24

(57) ABSTRACT

Disclosed herein is a bench-top time of flight mass spectrometer. In embodiments, there is provided a solvent bottle mounting assembly configured so that a user can press a solvent bottle onto the solvent bottle mounting assembly in order to mount the solvent bottle to the mass spectrometer. Other embodiments relate to a vacuum arrangement comprising first and second vacuum chambers with respective first and second vacuum pumps wherein a backing line for the second vacuum pump is connected to the first vacuum chamber such that the second vacuum pump is backed to the first vacuum chamber. Also disclosed in a method of manufacturing a lens plate or electrode wherein a substrate is chemically etched to reduce a sharp cusp to provide a smoother edge profile.

### CROSS-REFERENCE TO RELATED APPLICATION

This application claims priority from and the benefit of U.S. Provisional Patent Application No. 62/678,843 filed on May 31, 2018. The entire content of this application is incorporated herein by reference.

### FIELD OF THE INVENTION

The present invention relates generally to mass spectrometry and in particular to a small footprint or bench-top Time of Flight (“TOF”) mass spectrometer which has particular application in the biopharmaceutical industry.

### BACKGROUND

Conventional mass spectrometers which may be used, for example, in the biopharmaceutical industry tend to be relatively complex and have a relatively large footprint.

Scientists in the biopharmaceutical industry need to collect high resolution accurate mass data for their samples in order to provide more comprehensive information than can be obtained using LCUV analysis. Conventionally, this is typically achieved either by running relatively complex mass spectrometry equipment or by outsourcing the analysis to a specialist service.

It is desired to provide a reduced footprint Time of Flight (“TOF”) mass spectrometer which may have particular application in the biopharmaceutical industry.

In particular, because mass spectrometers are typically highly complex instruments containing many components that may need to be manufactured and installed with high precision, this means that manufacturing and maintenance costs can often be relatively high and/or the instrument may be relatively user unfriendly.

It is thus desired to simplify the mechanical design of the instrument where possible.

### SUMMARY

From a first main aspect of the present invention there is provided a mass spectrometer comprising:

one or more solvent bottle mounting assembly(ies) for mounting a corresponding one or more solvent bottle(s) to the mass spectrometer, wherein each solvent bottle mounting assembly is associated with a respective solvent line for introducing solvent into the mass spectrometer, and each solvent bottle mounting assembly comprises a sealing element through which the respective solvent line passes,

wherein each solvent bottle mounting assembly is configured so that a user can press a solvent bottle onto the solvent bottle mounting assembly in order to mount the solvent bottle to the mass spectrometer, wherein when a solvent bottle is mounted to the mass spectrometer using a solvent bottle mounting assembly the respective solvent line extends into the solvent bottle to allow solvent to be transferred from the solvent bottle to the mass spectrometer and the sealing element otherwise seals the opening of the solvent bottle.

Thus, in embodiments of the first main aspect, a mass spectrometer is provided with solvent bottle mounting means that allows a solvent bottle to be mounted by simply pressing the bottle into position onto the mass spectrometer, i.e. without requiring the solvent bottle to be screwed onto the instrument as in conventional arrangements. That is, the conventional screw mounts may be replaced with, for example, a resilient spring mount that allows a solvent bottle to be pressed into position to fit the solvent bottle to the mass spectrometer. Solvent bottles can thus be mounted to the mass spectrometer in an easy way that maintains the orientation of the bottles. In this way, the user can ensure that the solvent bottle is correctly oriented, e.g. with the label facing outwardly. By contrast, in conventional arrangements where the solvent bottles are screwed into position on the instrument, the label on the bottles often ends up facing away from the user so that the user cannot easily ascertain which bottles are connected.

Each solvent bottle mounting assembly comprises a sealing element that acts to seal the opening of a solvent bottle mounted thereto. Each solvent bottle mounting assembly is also associated with a solvent line that extends through the sealing element to allow solvent to be transferred from the bottle through the sealing element and into the mass spectrometer. The sealing element thus provides a substantially air tight seal to prevent solvent evaporation to the atmosphere so that solvent can effectively only be transferred from the solvent bottle through the solvent line. In the mounting position, the sealing element thus effectively seals the opening of the solvent bottle (except where the solvent line extends through the sealing element).

For instance, each solvent bottle mounting assembly may comprise one or more resilient spring. The resilient spring(s) may be arranged such that when a solvent bottle is mounted to a solvent bottle mounting assembly, the resilient spring(s) acts to bias the sealing element onto the opening of the solvent bottle. That is, when a solvent bottle is pressed into the mounting position on the solvent bottle mounting assembly, the resilient spring(s) acts to bias the sealing element onto the opening of a solvent bottle. The resilient spring may generally be connected (directly or indirectly) to the sealing element. The resilient spring may thus act to push the sealing element onto the opening of the bottle to form the desired sealing fit. It will be appreciated that the resilient spring may also help to hold the bottle in place.

In order to facilitate the mounting of a solvent bottle onto the solvent bottle mounting assembly, the sealing element may generally be moveable or otherwise deformable. Thus, when a solvent bottle is pressed against the sealing element, the sealing element may move or otherwise deform to allow the solvent bottle to be pressed into the mounting position and thereby mounted to the mass spectrometer.

For instance, the flexibility of the sealing element itself may be sufficient to allow a solvent bottle to be pressed onto the solvent bottle mounting assembly. In other cases, the resilient spring may provide sufficient flexibility to allow the sealing element to suitably move or deform to allow a solvent bottle to be pressed into the mounting position on the solvent bottle mounting assembly. However, various other arrangements are of course possible.

For example, in embodiments, the sealing element may be moveable between an open position ready for receiving a solvent bottle to be mounted and a mounting position in which the solvent bottle is mounted in position. For instance, each solvent bottle mounting assembly may comprise a hinge or pivot so that the sealing element can be pivoted (moved) between the open position ready and the mounting position in which the solvent bottle is mounted in position. A resilient spring may then be used for biasing the moveable sealing element away from the mounting position. When a solvent bottle is pressed against the sealing element and moved into the mounting position, the spring may thus act to push the sealing element onto the opening of the solvent bottle to form a tight sealing fit, as described above.

A backstop may also be provided against which the base of a solvent bottle can rest in the mounting position. That is, in embodiments, each solvent bottle mounting assembly may include a backstop, wherein when a solvent bottle is mounted onto the solvent bottle mounting assembly, the base of the solvent bottle rests against the backstop. In this way, the solvent bottle may thus be held in place (once mounted) between the sealing element and the backstop. That is, the solvent bottle may be held at its top (the opening) by the sealing element and at its base by the backstop. Where a resilient spring is provided that acts to push the sealing element towards the opening of a solvent bottle in the mounting position, the spring may thus help to hold the solvent bottle in place on the backstop.

Solvents are typically sold in certain standard bottle sizes. The height of the backstop may thus be selected to correspond to a (known) standard size of solvent bottle. Particularly, the distance between the backstop and the sealing element in the mounting position may be selected to correspond to a standard size of solvent bottle. In embodiments, a plurality of solvent bottle mounting assemblies may be provided each having a respective backstop, wherein the respective backstops of the plurality of solvent bottle mounting assemblies each have a different height for accommodating a different size of solvent bottle. This may help ensure solvent bottles are only installed on the correct solvent lines.

Alternatively, or additionally, the solvent bottle mounting assembly may comprise one or more resilient clips for holding the solvent bottle in place. A solvent bottle may thus be press fit into a resilient clip in order to mount the solvent bottle to the mass spectrometer.

The sealing element may generally comprise any suitable resilient (elastic) material, such as rubber, suitable for forming an airtight seal around the opening of a solvent bottle. The sealing element may comprise a tapered portion for sealing around the inner circumference of the solvent bottle opening. The tapered portion may thus fit into the opening of a solvent bottle to form a seal around the inner surface of the solvent bottle opening.

The solvent bottles may generally be mounted within a recess provided on an external surface of the mass spectrometer. For example, the solvent bottle mounting assembly(ies) may be arranged within a recess provided on an external surface of the mass spectrometer. By providing the solvent bottle mounting assembly(ies) within a suitable recess on the surface of the mass spectrometer, the external surface can be kept substantially level, i.e. so that the solvent bottles when mounted do not protrude outwardly from the surface (thus avoiding the possibility of the solvent bottles being knocked in use). Typically, the solvent bottle mounting assembly(ies) may be provided on the front surface of the mass spectrometer. The solvent bottles can thus easily be accessed and inspected by a user. The external surface may also include a display for displaying information regarding the current operating status of the mass spectrometer. The user can thus easily see the current operating status of the mass spectrometer as well as the status of the solvent bottles at the same time.

In order to better show the fill level of the solvent bottles, the solvent bottles may be illuminated. Particularly, the solvent bottles may be back lit using an LED light tile. Thus, in embodiments, the mass spectrometer may further comprise a light source for illuminating solvent bottles that have been mounted onto the mass spectrometer using the solvent bottle mounting assembly. Particularly, the light source may be arranged so that solvent bottles are mounted to the mass spectrometer, the solvent bottles are illuminated from behind. For instance, where the solvent bottle mounting assembly(s) are provided within a recess on an external surface of a mass spectrometer, the light source may be provided on the recessed surface. Any suitable light source may be used. However, in embodiments, the light source may comprise an LED light tile.

It will be appreciated that the solvent lines may be connected to any suitable internal solvent ports of the mass spectrometer, as desired, for introducing solvent into the mass spectrometer. For example, a solvent line may be connected to a respective solvent port within the source region of the mass spectrometer for providing solvent thereto. However, other arrangements would of course be possible. Each solvent line may thus be open at the end that is to be inserted into a solvent bottle and connected at the other end to a solvent port within the mass spectrometer.

There is also provided a method of mounting one or more solvent bottles onto a mass spectrometer substantially as described herein in relation to the first main aspect in any of its embodiments. The method may comprise mounting an open solvent bottle onto the mass spectrometer by pressing the open solvent bottle into position onto a corresponding solvent bottle mounting assembly of the mass spectrometer. The solvent bottle can thereby be mounted onto the mass spectrometer.

Mass analysers such as Time of Flight (TOF) mass analysers must typically be operated under relatively high vacuum conditions. Thus, in order to efficiently transfer ions from a relatively higher (e.g. atmospheric) pressure source region of a mass spectrometer towards the mass analyser, it is common to provide one or more stages of differential pumping whereby the pressure is reduced in stages along consecutive vacuum regions along the mass spectrometer. For instance, it is known to use a relatively low vacuum roughing pump such as a rotary vacuum pump or diaphragm pump to pump a first differential pumping region to a base pressure and then use one or more high vacuum pumps such as one or more turbo molecular vacuum pumps to pump subsequent vacuum regions to lower pressures.

However, high vacuum pumps such as turbo molecular vacuum pumps are typically unable to exhaust to atmospheric pressure and a backing vacuum pump must normally be provided for backing to the high vacuum pump. That is, the exhaust of the turbo molecular pump is typically connected (‘backed’) to a mechanical backing pump for producing a low enough pressure for the high vacuum pump to work efficiently.

A separate pump could be provided for backing the high vacuum pump. However, this may generally increase the footprint of the instrument. Accordingly, in some known arrangements, the vacuum line from the roughing pump used for pumping the first differential pumping region may be split, for example using a suitable tee connector, so that a portion of the vacuum pumping from the roughing pump is also used for backing the high vacuum pump. That is, a single roughing/backing pump may be provided. This may help reduce the physical size of the vacuum system. However, this arrangement requires a number of additional connections, each of which provides a potential leak point and therefore requires careful vacuum sealing to maintain the desired pressure.

It may therefore be desired to provide an improved and simplified vacuum pumping arrangement.

Thus, from a second main aspect of the present invention, there is provided a mass spectrometry apparatus comprising:

a mass spectrometer comprising a first vacuum chamber and a second vacuum chamber;

a first vacuum pump connected to the first vacuum chamber for pumping the first vacuum chamber to a first pressure; and

a second vacuum pump comprising a vacuum port connected to the second vacuum chamber for pumping the second vacuum chamber;

wherein a backing line for the second vacuum pump is connected to the first vacuum chamber such that the second vacuum pump is backed to the first vacuum chamber.

According to embodiments of the second main aspect, a separate backing line for the second vacuum pump is provided that is connected to the first vacuum chamber. The first vacuum chamber thus acts as a backing vacuum for the second vacuum pump. Considered another way, the first vacuum pump may now act as a backing pump to the second vacuum pump through (or via) the first vacuum chamber. In this way, the vacuum system may be simplified so that the number of physical connections, and potential leak points, can therefore be reduced without having to increase the number of vacuum pumps or the physical footprint of the vacuum system. This may in turn reduce the costs associated with manufacture and maintenance of the mass spectrometer. A simplified construction and maintenance may thus be provided.

The second vacuum pump is generally a ‘high vacuum’ pump. The second vacuum pump may comprise any suitable high vacuum pump, as desired. For instance, in some examples, the second vacuum pump may comprise a diffusion pump. However, in embodiments, the second vacuum pump may comprise a turbo molecular vacuum pump, and particularly a split flow turbo molecular vacuum pump. The second vacuum pump is thus generally used to maintain the second vacuum chamber at a relatively low pressure (high vacuum). That is, the second vacuum pump is generally configured to pump the second vacuum chamber to a second pressure, wherein the second pressure is lower than the (first) pressure of the first vacuum chamber. The second vacuum pump may therefore typically be connected to an analytical stage of the mass spectrometer, downstream of the source region. In particular the second vacuum chamber may comprise a vacuum chamber in which the ultimate mass analyser and/or ion detector is housed. The second vacuum chamber may thus be an analytical stage of the mass spectrometer. For example, the second vacuum chamber may contain a Time of Flight mass analyser. Accordingly, the second vacuum pump may suitably be configured to maintain the second vacuum chamber in use at a pressure of less than about: (i) 10⁻⁴ mbar; (ii) 10⁻⁵ mbar; or (iii) 10⁻⁶ mbar.

The second vacuum pump may thus be used to achieve the fine or high vacuum conditions required in the analytical stages of the mass spectrometer. On the other hand, the first vacuum pump may generally be used to maintain a base or rough pressure. For instance, the first vacuum pump may suitably be connected to a source region, or source transfer region, of the mass spectrometer wherein lower vacuum conditions may be required. For instance, the first vacuum pump may be configured to maintain the first vacuum chamber in use at a pressure of less than about: (i) 10 mbar; or (ii) 5 mbar. Particularly, the first vacuum pump may be configured to maintain the first vacuum chamber in use at a pressure between about 10⁻¹ mbar and about 5 or 10 mbar. The first vacuum pump may be referred to as a ‘roughing’ and/or ‘backing’ pump. Any suitable vacuum pump may be used for the first vacuum pump. For instance, in embodiments, the first vacuum pump may comprise a rotary vane vacuum pump or a diaphragm vacuum pump.

The mass spectrometer may typically comprise a plurality of vacuum chambers such as three, four or more vacuum chambers. Each of the vacuum chambers may be separated by a differential pumping aperture with the pressures in the chambers typically decreasing in sequence along the instrument (i.e. from the source region to the ion detector). Thus, in embodiments, the mass spectrometer also includes one or more intermediate vacuum chambers disposed between the first and second vacuum chambers. The intermediate vacuum chambers may generally be maintained at intermediate pressures, i.e. between the first and second pressures at which the first and second vacuum chambers are maintained.

For instance, the first vacuum chamber may comprise a source transfer region containing an ion guide for receiving ions generated in the source region and the second vacuum chamber may comprise a Time of Flight mass analyser. One or more intermediate vacuum chambers may then be provided that comprise various ion optical elements such as one or more ion guides, ion filters, fragmentation or reaction regions, and transfer lenses. For example, in a particular embodiment, the mass spectrometer may comprise four vacuum chambers wherein the first vacuum chamber may contain a source ion guide and may be maintained by the first vacuum pump at a pressure of less than about 5 mbar, the next vacuum chamber may contain an ion guide and may be maintained at a pressure of less than 2×10⁻² mbar, the next vacuum chamber may contain a transfer lens assembly and may be maintained at a pressure of less than about 2×10⁻⁴ mbar, and the final (second) vacuum chamber may then contain the TOF analyser and may be maintained at a pressure of less than about 10⁻⁶ mbar.

In principle, the instrument may include further vacuum pumps for (each of) the further vacuum chambers. However, in embodiments, particularly where the second vacuum pump is a split flow turbo molecular vacuum pump, and where the second vacuum pump may therefore comprise a plurality of vacuum ports, the second vacuum pump may also be used for pumping the further vacuum chambers.

For instance, in addition to the vacuum port connected to the second vacuum chamber, the second vacuum pump may further comprise one or more further (intermediate) vacuum ports, and the one or more further vacuum ports of the second vacuum pump may be connected to one or more further vacuum chambers disposed between the first and second vacuum chambers. For instance, a first (high) vacuum port of the second vacuum pump may be connected to the second vacuum chamber for pumping the second vacuum chamber to a second pressure, and a further (intermediate) vacuum port of the second vacuum pump may be connected to an intermediate vacuum chamber disposed between the first and second vacuum chambers for pumping the intermediate vacuum chamber to an intermediate pressure between the first and second pressures.

Typically, a three stage second vacuum pump may be used comprising a high vacuum port and two intermediate vacuum ports. In this case, the high vacuum port may be connected to the second vacuum chamber and the two intermediate vacuum ports each connected to a respective intermediate vacuum chamber.

That is, in embodiments, a single first vacuum pump may be used to evacuate the first vacuum chamber whilst a single split flow turbo molecular pump is used to evacuate multiple downstream vacuum chambers. As described above, the turbo molecular pump is backed by the same vacuum pump used to evacuate the first vacuum chamber. That is, in embodiments, the number of vacuum pumps may be limited to two helping to further reduce the number of components and footprint of the mass spectrometer.

There is also provided a method of operating a mass spectrometry apparatus substantially as described herein, particularly with reference to the second main aspect, the method comprising using the first vacuum pump to pump the first vacuum chamber to a first pressure, and when the first vacuum chamber reaches the first pressure, using the second vacuum pump to pump the second vacuum chamber to a second pressure, wherein the second pressure is lower than the first pressure. It will be appreciated that the mass spectrometer that is being operated according to this method may generally comprise any or all features described herein in relation to the present invention in any of its aspects and embodiments.

Metallic elements such as lens plates or other electrodes for use within mass spectrometry instruments may require relatively high precision dimensioning. Conventionally such elements may be formed using known chemical etch and/or machining processes. However, it is desired to provide an improved method for manufacturing a lens plate or electrode for use within a mass spectrometer.

Accordingly, from a third main aspect, there is provided a method of manufacturing a lens plate or electrode for use within a mass spectrometer, the method comprising:

providing a substrate for chemical etching, the substrate comprising on both faces a mask that defines a pattern of features for the lens plate or electrode; and

chemically etching the substrate, wherein the chemical etching is performed such that a sharp cusp formed along an edge of the substrate between the faces of the substrate is reduced in order to provide a smoother edge profile.

In this way, a lens plate or electrode having a substantially smooth or flat edge profile between the two faces thereof can be produced using a chemical etching process. Particularly, by chemically etching the substrate such that the sharpness of a cusp that is formed along the edge of the substrate when the substrate is being etched from both sides is reduced, it is possible to achieve a smoother edge profile. That is, the chemical etching may be performed so that a cusp that is formed during the chemical etching step is then reduced or substantially removed. The edge of the element is thus provided with a smoother profile than would be the case e.g. if the element was removed from the etchant before the cusp had been significantly reduced.

For instance, in order to define a desired pattern of features for the lens plate or electrode, a mask (or masking tool) comprising a suitably non-corrosive material may be provided on one (and normally both) faces of the substrate of the substrate. The chemical etching thus acts to remove exposed material that is not covered by the mask to define the features of the lens plate or electrode. However, chemical etching will not generate perfectly straight cuts when cutting through the thickness a substrate, such that chemically etched substrates will typically have a sloped or curved edge profile (i.e. the profile perpendicular to the faces of the substrate that are being patterned)

When a substrate is etched from both sides, the effect of this is that a relatively sharp cusp will tend to form along the edges of the substrate between the two faces. This cusp would potentially create various problems if the element were to be used as a lens plate or electrode within a mass spectrometer as applying an electric potential to the element may cause unwanted electric and magnetic field distortions in the region of the cusp. Thus, in conventional approaches, to achieve a smoother edge profile, the element would then be finished using relatively expensive mechanical grinding techniques.

By contrast, according to embodiments of the third main aspect, the chemical etching is performed such that a sharp cusp that is initially formed along an edge of the substrate during the chemical etching process is then reduced to provide a smoother, or substantially flat, edge profile. That is, it has been recognised that the sharpness of the cusp that is formed when etching a substrate can be reduced during the chemical etching. For example, by allowing the chemical etchant to remove more material from the substrate, the etchant will start to remove the cusp, resulting in a smoother edge profile. For instance, by leaving the substrate in the chemical etchant for longer, the cusp may form, but the chemical etching process can then be allowed to continue removing material from the substrate in order to reduce the sharpness of the cusp and provide a substantially smoother edge profile.

In embodiments, after a first chemical etch has been performed, as described above, a second or further chemical etch may then be performed to finish the lens plate or electrode. The second or further chemical etch may generally be similar to the first chemical etch, e.g. using the same etchant and mask, but may have a relatively shorter duration.

In order to create an element having features of a desired (target) shape and size, it is known to select a suitably sized mask (pattern) in order to compensate for the lateral etching. It will be appreciated that in order to maintain the desired size for the features of the lens plate or electrode, a relatively oversized mask (pattern) may thus be used so that the chemical etching can be left to remove more material from the substrate. Thus, in embodiments, for a lens plate or electrode having features of a target lateral dimension the size of the mask may be selected based on the thickness of the substrate so as to allow the chemical etching to remove a sufficient amount of substrate material to reduce the sharp cusp formed along the lateral and provide a smoother edge profile whilst still providing features having the target lateral dimension. In other words, the size of the mask may be selected to ‘overcompensate’ the chemical etching. This may allow the substrate to be etched for longer so that the etchant removes more material and reduces the sharpness of the cusp whilst still maintaining the desired lateral dimensions (i.e. shape and size) for the features of the lens plate or electrode. That is, for a given substrate having a certain thickness and a desired set of target features the size of the mask may be selected appropriately to overcompensate for the chemical etching to allow the chemical etching to remove more material from the substrate such that a sharp cusp formed along a lateral edge of the substrate is reduced to provide a substantially flatter edge profile whilst still providing features having the targeted lateral dimensions.

The amount of overcompensation may generally be selected as desired to give a substantially flatter edge profile. For instance, the appropriate overcompensation factor may generally be determined based on knowledge of the (lateral) etch factor and etch rate, e.g. as may be determined from previous experiments using the same substrate material and chemical etchant. Overcompensation factors of up to about 10%, such as of about 5%, have been found to be particularly suitable. Beyond this, the edge profile may start to become concave.

In this way, a lens plate or electrode with a relatively flatter edge profile can be formed without requiring expensive machining.

According to various embodiments a relatively small footprint or compact Time of Flight (“TOF”) mass spectrometer (“MS”) or analytical instrument is provided which has a relatively high resolution. The mass spectrometer may have particular application in the biopharmaceutical industry and in the field of general analytical Electrospray Ionisation (“ESI”) and subsequent mass analysis. The mass spectrometer according to various embodiments is a high performance instrument wherein manufacturing costs have been reduced without compromising performance.

The instrument according to various embodiments is particularly user friendly compared with the majority of other conventional instruments. The instrument may have single button which can be activated by a user in order to turn the instrument ON and at the same time initiate an instrument self-setup routine. The instrument may, in particular, have a health diagnostics system which is both helpful for users whilst providing improved diagnosis and fault resolution.

According to various embodiments the instrument may have a health diagnostics or health check which is arranged to bring the overall instrument, and in particular the mass spectrometer and mass analyser, into a state of readiness after a period of inactivity or power saving. The same health diagnostic system may also be utilised to bring the instrument into a state of readiness after maintenance or after the instrument switches from a maintenance mode of operation into an operational state. Furthermore, the health diagnostics system may also be used to monitor the instrument, mass spectrometer or mass analyser on a periodic basis in order to ensure that the instrument in operating within defined operational parameters and hence the integrity of mass spectral or other data obtained is not compromised.

The health check system may determine various actions which either should automatically be performed or which are presented to a user to decide whether or not to proceed with. For example, the health check system may determine that no corrective action or other measure is required i.e. that the instrument is operating as expected within defined operational limits. The health check system may also determine that an automatic operation should be performed in order, for example, to correct or adjust the instrument in response to a detected error warning, error status or anomaly. The health check system may also inform the user that the user should either take a certain course of action or to give approval for the control system to take a certain course of action. Various embodiments are also contemplated wherein the health check system make seek negative approval i.e. the health check system may inform a user that a certain course of action will be taken, optionally after a defined time delay, unless the user instructs otherwise or cancels the proposed action suggested by the control system.

Embodiments are also contemplated wherein the level of detail provided to a user may vary dependent upon the level of experience of the user. For example, the health check system may provide either very detailed instructions or simplified instructions to a relatively unskilled user.

The health check system may provide a different level of detail to a highly skilled user such as a service engineer. In particular, additional data and/or instructions may be provided to a service engineer that may not be provided to a regular user. It is also contemplated that instructions given to a regular user may include icons and/or moving graphical images. For example, a user may be guided by the health check system in order to correct a fault and once it is determined that a user has completed a step then the control system may change the icon and/or moving graphical images which are displayed to the user in order to continue to guide the user through the process.

The instrument according to various embodiments has been designed to be as small as possible whilst also being generally compatible with existing UPLC systems. The instrument is easy to operate and has been designed to have a high level of reliability. Furthermore, the instrument has been designed so as to simplify diagnostic and servicing thereby minimising instrument downtime and operational costs.

According to various embodiments the instrument has particular utility in the health services market and may be integrated with Desorption Electrospray Ionisation (“DESI”) and Rapid Evaporative Ionisation Mass Spectrometry (“REIMS”) ion sources in order to deliver commercially available In Vitro Diagnostic Medical Device (“IVD”)/Medical Device (“MD”) solutions for targeted applications.

The mass spectrometer may, for example, be used for microbe identification purposes, histopathology, tissue imaging and surgical (theatre) applications.

The mass spectrometer has a significantly enhanced user experience compared with conventional mass spectrometers and has a high degree of robustness. The instrument is particularly easy to use (especially for non-expert users) and has a high level of accessibility.

The mass spectrometer has been designed to integrate easily with liquid chromatography (“LC”) separation systems so that a LC-TOF MS instrument may be provided. The instrument is particularly suited for routine characterisation and monitoring applications in the biopharmaceutical industry. The instrument enables non-expert users to collect high resolution accurate mass data and to derive meaningful information from the data quickly and easily. This results in improved understanding of products and processes with the potential to shorten time to market and reduce costs.

The instrument may be used in biopharmaceutical last stage development and quality control (“QC”) applications. The instrument also has particular application in small molecule pharmaceutical, food and environmental (“F&E”) and chemical materials analyses.

The instrument has enhanced mass detection capabilities i.e. high mass resolution, accurate mass and an extended mass range. The instrument also has the ability to fragment parent ions into daughter or fragment ions so that MS/MS type experiments may be performed.

### BRIEF DESCRIPTION OF THE DRAWINGS

Various embodiments together with other arrangements given for illustrative purposes only will now be described, by way of example only, and with reference to the accompanying drawings in which:

FIG. 1 shows a perspective view of a bench-top Time of Flight mass spectrometer according to various embodiments coupled to a conventional bench-top liquid chromatography (“LC”) separation system;

FIG. 2A shows a front view of a bench-top mass spectrometer according to various embodiments showing three solvent bottles loaded into the instrument and a front display panel, FIG. 2B shows a perspective view of a mass spectrometer according to various embodiments and FIG. 2C illustrates in more detail various icons which may be displayed on the front display panel in order to highlight the status of the instrument to a user and to indicate if a potential fault has been detected;

FIG. 3 shows a schematic representation of mass spectrometer according to various embodiments, wherein the instrument comprises an Electrospray Ionisation (“ESI”) or other ion source, a conjoined ring ion guide, a segmented quadrupole rod set ion guide, one or more transfer lenses and a Time of Flight mass analyser comprising a pusher electrode, a reflectron and an ion detector;

FIG. 4 shows a known Atmospheric Pressure Ionisation (“API”) ion source which may be used with the mass spectrometer according to various embodiments;

FIG. 5 shows a first known ion inlet assembly which shares features with an ion inlet assembly according to various embodiments;

FIG. 6A shows an exploded view of the first known ion inlet assembly, FIG. 6B shows a second different known ion inlet assembly having an isolation valve, FIG. 6C shows an exploded view of an ion inlet assembly according to various embodiments, FIG. 6D shows the arrangement of an ion block attached to a pumping block upstream of a vacuum chamber housing a first ion guide according to various embodiments, FIG. 6E shows in more detail a fixed valve assembly which is retained within an ion block according to various embodiments, FIG. 6F shows the removal by a user of a cone assembly attached to a clamp to expose a fixed valve having a gas flow restriction aperture which is sufficient to maintain the low pressure within a downstream vacuum chamber when the cone is removed and FIG. 6G illustrates how the fixed valve may be retained in position by suction pressure according to various embodiments;

FIG. 7A shows a pumping arrangement according to various embodiments, FIG. 7B shows further details of a gas handling system which may be implemented, FIG. 7C shows a flow diagram illustrating the steps which may be performed following a user request to the turn the Atmospheric Pressure Ionisation (“API”) gas ON and FIG. 7D shows a flow chart illustrating a source pressure test which may be performed according to various embodiments;

FIG. 8 shows in more detail a mass spectrometer according to various embodiments;

FIG. 9 shows a Time of Flight mass analyser assembly comprising a pusher plate assembly having mounted thereto a pusher electronics module and an ion detector module and wherein a reflectron assembly is suspended from an extruded flight tube which in turn is suspended from the pusher plate assembly;

FIG. 10A shows in more detail a pusher plate assembly, FIG. 10B shows a monolithic pusher plate assembly according to various embodiments and FIG. 10C shows a pusher plate assembly with a pusher electrode assembly or module and an ion detector assembly or module mounted thereto;

FIG. 11 shows a flow diagram illustrating various processes which occur upon a user pressing a start button on the front panel of the instrument according to various embodiments;

FIG. 12A shows in greater detail three separate pumping ports of a turbo molecular pump according to various embodiments and FIG. 12B shows in greater detail two of the three pumping ports which are arranged to pump separate vacuum chambers;

FIG. 13 shows in more detail a transfer lens arrangement;

FIG. 14A shows details of a known internal vacuum configuration and FIG. 14B shows details of a new internal vacuum configuration according to various embodiments;

FIG. 15A shows a schematic of an arrangement of ring electrodes and conjoined ring electrodes forming a first ion guide which is arranged to separate charged ions from undesired neutral particles, FIG. 15B shows a resistor chain which may be used to produce a linear axial DC electric field along the length of a first portion of the first ion guide and FIG. 15C shows a resistor chain which may be used to produce a linear axial DC electric field along the length of a second portion of the first ion guide;

FIG. 16A shows in more detail a segmented quadrupole rod set ion guide according to various embodiments which may be provided downstream of the first ion guide and which comprises a plurality of rod electrodes, FIG. 16B illustrates how a voltage pulse applied to a pusher electrode of a Time of Flight mass analyser may be synchronised with trapping and releasing ions from the end region of the segmented quadrupole rod set ion guide, FIG. 16C illustrates in more detail the pusher electrode geometry and shows the arrangement of grid and ring lenses or electrodes and their relative spacing, FIG. 16D illustrates in more detail the overall geometry of the Time of Flight mass analyser including the relative spacings of elements of the pusher electrode and associated electrodes, the reflectron grid electrodes and the ion detector, FIG. 16E is a schematic illustrating the wiring arrangement according to various embodiments of the pusher electrode and associated grid and ring electrodes and the grid and ring electrodes forming the reflectron, FIG. 16F illustrates the relative voltages and absolute voltage ranges at which the various ion optical components such as the Electrospray capillary probe, differential pumping apertures, transfer lens electrodes, pusher electrodes, reflectron electrodes and the detector are maintained according to various embodiments, FIG. 16G is a schematic of an ion detector arrangement according to various embodiments and which shows various connections to the ion detector which are located both within and external to the Time of Flight housing and FIG. 16H shows an illustrative potential energy diagram;

FIG. 17A and FIG. 17B show in more detail the arrangement for mounting solvent bottles onto the instrument; and

FIG. 18A illustrates an example of a chemical etch process that may be used to manufacture an electrode or lens plate for use within a mass spectrometer; FIG. 18B shows an example of a lens plate manufactured according to a conventional chemical etching process; and FIG. 18C shows an example of a lens plate manufacture according to various embodiments.

### DETAILED DESCRIPTION

Various aspects of a newly developed mass spectrometer are disclosed. The mass spectrometer comprises a modified and improved ion inlet assembly, a modified first ion guide, a modified quadrupole rod set ion guide, improved transfer optics, a novel cantilevered time of flight arrangement, a modified reflectron arrangement together with advanced electronics and an improved user interface.

The mass spectrometer has been designed to have a high level of performance, to be highly reliable, to offer a significantly improved user experience compared with the majority of conventional mass spectrometers, to have a very high level of EMC compliance and to have advanced safety features.

The instrument comprises a highly accurate mass analyser and overall the instrument is small and compact with a high degree of robustness. The instrument has been designed to reduce manufacturing cost without compromising performance at the same time making the instrument more reliable and easier to service. The instrument is particularly easy to use, easy to maintain and easy to service. The instrument constitutes a next-generation bench-top Time of Flight mass spectrometer.

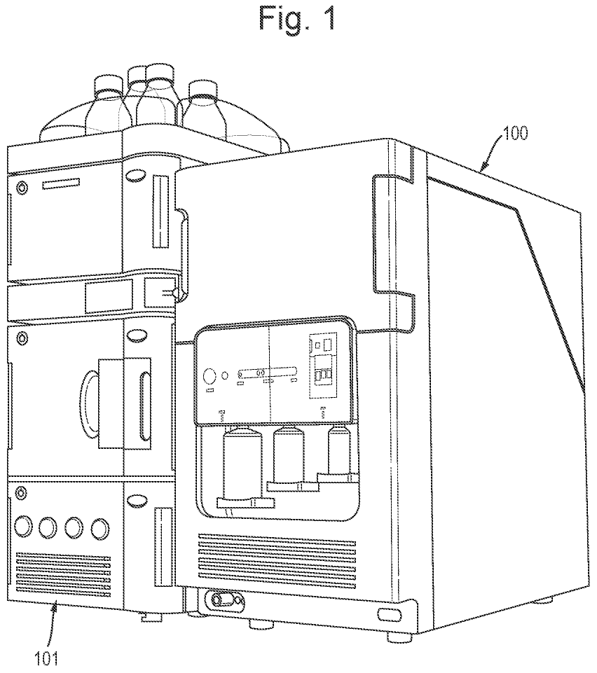

FIG. 1 shows a bench-top mass spectrometer 100 according to various embodiments which is shown coupled to a conventional bench-top liquid chromatography separation device 101. The mass spectrometer 100 has been designed with ease of use in mind. In particular, a simplified user interface and front display is provided and instrument serviceability has been significantly improved and optimised relative to conventional instruments. The mass spectrometer 100 has an improved mechanical design with a reduced part count and benefits from a simplified manufacturing process thereby leading to a reduced cost design, improved reliability and simplified service procedures. The mass spectrometer has been designed to be highly electromagnetic compatible (“EMC”) and exhibits very low electromagnetic interference (“EMI”).

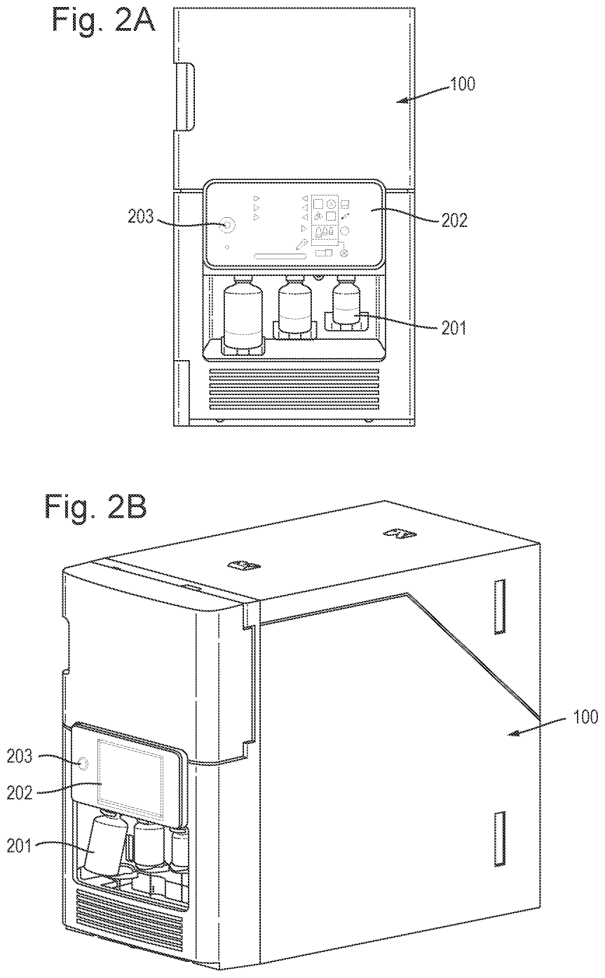

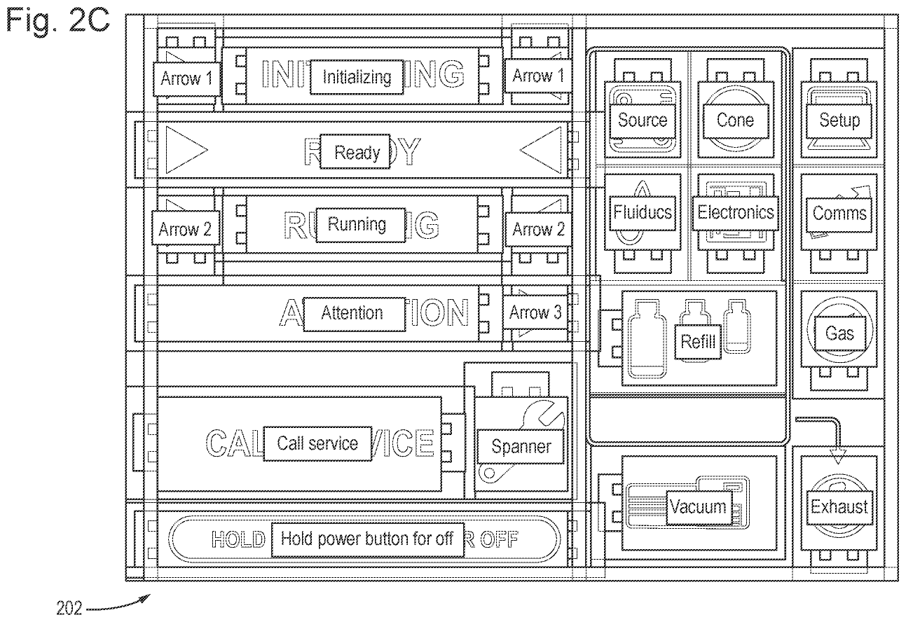

FIG. 2A shows a front view of the mass spectrometer 100 according to various embodiments and FIG. 2B shows a perspective view of the mass spectrometer according to various embodiments. Three solvent bottles 201 may be coupled, plugged in or otherwise connected or inserted into the mass spectrometer 100. The solvent bottles 201 may be back lit in order to highlight the fill status of the solvent bottles 201 to a user.

One problem with a known mass spectrometer having a plurality of solvent bottles is that a user may connect a solvent bottle in a wrong location or position. Furthermore, a user may mount a solvent bottle but conventional mounting mechanisms will not ensure that a label on the front of the solvent bottle will be positioned so that it can be viewed by a user i.e. conventional instruments may allow a solvent bottle to be connected where a front facing label ends up facing away from the user. Accordingly, one problem with conventional instruments is that a user may not be able to read a label on a solvent bottle due to the fact that the solvent bottle ends up being positioned with the label of the solvent bottle facing away from the user. According to various embodiments conventional screw mounts which are conventionally used to mount solvent bottles have been replaced with a resilient spring mounting mechanism which allows the solvent bottles 201 to be connected without rotation. This will be described further below.

According to various embodiments the solvent bottles 201 may be illuminated by a LED light tile in order to indicate the fill level of the solvent bottles 201 to a user. It will be understood that a single LED illuminating a bottle will be insufficient since the fluid in a solvent bottle 201 can attenuate the light from the LED. Furthermore, there is no good single position for locating a single LED.

The mass spectrometer 100 may have a display panel 202 upon which various icons may be displayed when illuminated by the instrument control system.

A start button 203 may be positioned on or adjacent the front display panel 202. A user may press the start button 203 which will then initiate a power-up sequence or routine. The power-up sequence or routine may comprise powering-up all instrument modules and initiating instrument pump-down i.e. generating a low pressure in each of the vacuum chambers within the body of the mass spectrometer 100.

According to various embodiments the power-up sequence or routine may or may not include running a source pressure test and switching the instrument into an Operate mode of operation.

According to various embodiments a user may hold the start button 203 for a period of time, e.g. 5 seconds, in order to initiate a power-down sequence.

If the instrument is in a maintenance mode of operation then pressing the start button 203 on the front panel of the instrument may initiate a power-up sequence. Furthermore, when the instrument is in a maintenance mode of operation then holding the start button 203 on the front panel of the instrument for a period of time, e.g. 5 seconds, may initiate a power-down sequence.

FIG. 2C illustrates in greater detail various icons which may be displayed on the display panel 202 and which may illuminated under the control of instrument hardware and/or software. According to various embodiments one side of the display panel 202 (e.g. the left-hand side) may have various icons which generally relate to the status of the instrument or mass spectrometer 100. For example, icons may be displayed in the colour green to indicate that the instrument is in an initialisation mode of operation, a ready mode of operation or a running mode of operation.

In the event of a detected error which may require user interaction or user input a yellow or amber warning message may be displayed. A yellow or amber warning message or icon may be displayed on the display panel 202 and may convey only relatively general information to a user e.g. indicating that there is a potential fault and a general indication of what component or aspect of the instrument may be at fault.

According to various embodiments it may be necessary for a user to refer to an associated computer display or monitor in order to get fuller details or gain a fuller appreciation of the nature of the fault and to receive details of potential corrective action which is recommended to perform in order to correct the fault or to place the instrument in a desired operational state.

A user may be invited to confirm that a corrective action should be performed and/or a user may be informed that a certain corrective action is being performed.

In the event of a detected error which cannot be readily corrected by a user and which instead requires the services of a skilled service engineer then a warning message may be displayed indicating that a service engineer needs to be called. A warning message indicating the need for a service engineer may be displayed in the colour red and a spanner or other icon may also be displayed or illuminated to indicate to a user that an engineer is required.

The display panel 202 may also display a message that the power button 203 should be pressed in order to turn the instrument OFF.

According to an embodiment one side of the display panel 202 (e.g. the right-hand side) may have various icons which indicate different components or modules of the instrument where an error or fault has been detected. For example, a yellow or amber icon may be displayed or illuminated in order to indicate an error or fault with the ion source, a fault in the inlet cone region, a fault with the fluidic systems, an electronics fault, a fault with one or more of the solvent or other bottles 201 (i.e. indicating that one or more solvent bottles 201 needing to be refilled or emptied), a vacuum pressure fault associated with one or more of the vacuum chambers, an instrument setup error, a communication error, a problem with a gas supply or a problem with an exhaust.

It will be understood that the display panel 202 may merely indicate the general status of the instrument and/or the general nature of a fault. In order to be able to resolve the fault or to understand the exact nature of an error or fault a user may need to refer to the display screen of an associated computer or other device. For example, as will be understood by those skilled in the art an associated computer or other device may be arranged to receive and process mass spectral and other data output from the instrument or mass spectrometer 100 and may display mass spectral data or images on a computer display screen for the benefit of a user.

According to various embodiments the status display may indicate whether the instrument is in one of the following states namely Running, Ready, Getting Ready, Ready Blocked or Error.

The status display may display health check indicators such as Service Required, Cone, Source, Set-up, Vacuum, Communications, Fluidics, Gas, Exhaust, Electronics, Lock-mass, Calibrant and Wash.

A “Hold power button for OFF” LED tile is shown in FIG. 2C and may remain illuminated when the power button 203 is pressed and may remain illuminated until the power button 203 is released or until a period of time (e.g. 5 seconds) has elapsed whichever is sooner. If the power button 203 is released before the set period of time (e.g. less than 5 seconds after it is pressed) then the “Hold power button for OFF” LED tile may fade out over a time period of e.g. 2 s.

The initialising LED tile may be illuminated when the instrument is started via the power button 203 and may remain ON until software assumes control of the status panel or until a power-up sequence or routine times out.

According to various embodiments an instrument health check may be performed and printer style error correction instructions may be provided to a user via a display screen of a computer monitor (which may be separate to the front display panel 202) in order to help guide a user through any steps that the user may need to perform.

The instrument may attempt to self-diagnose any error messages or warning status alert(s) and may attempt to rectify any problem(s) either with or without notifying the user.

Depending upon the severity of any problem the instrument control system may either attempt to correct the problem(s) itself, request the user to carry out some form of intervention in order to attempt to correct the issue or problem(s) or may inform the user that the instrument requires a service engineer.

In the event where corrective action may be taken by a user then the instrument may display instructions for the user to follow and may provide details of methods or steps that should be performed which may allow the user to fix or otherwise resolve the problem or error. A resolve button may be provided on a display screen which may be pressed by a user having followed the suggested resolution instructions. The instrument may then run a test again and/or may check if the issue has indeed been corrected. For example, if a user were to trigger an interlock then once the interlock is closed a pressure test routine may be initialised as detailed below.

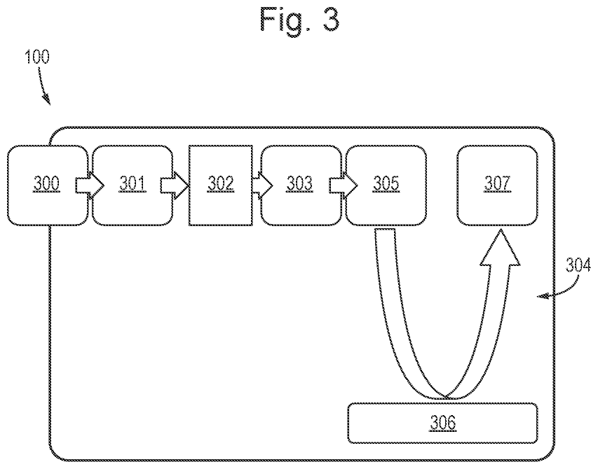

FIG. 3 shows a high level schematic of the mass spectrometer 100 according to various embodiments wherein the instrument may comprise an ion source 300, such as an Electrospray Ionisation (“ESI”) ion source. However, it should be understood that the use of an Electrospray Ionisation ion source 300 is not essential and that according to other embodiments a different type of ion source may be used. For example, according to various embodiments a Desorption Electrospray Ionisation (“DESI”) ion source may be used. According to yet further embodiments a Rapid Evaporative Ionisation Mass Spectrometry (“REIMS”) ion source may be used.

If an Electrospray ion source 300 is provided then the ion source 300 may comprise an Electrospray probe and associated power supply.

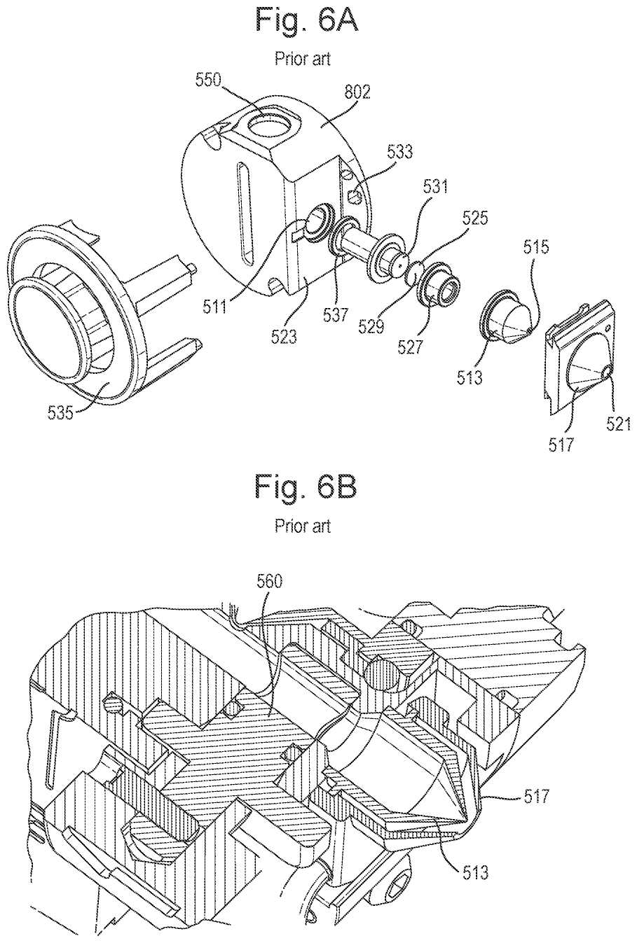

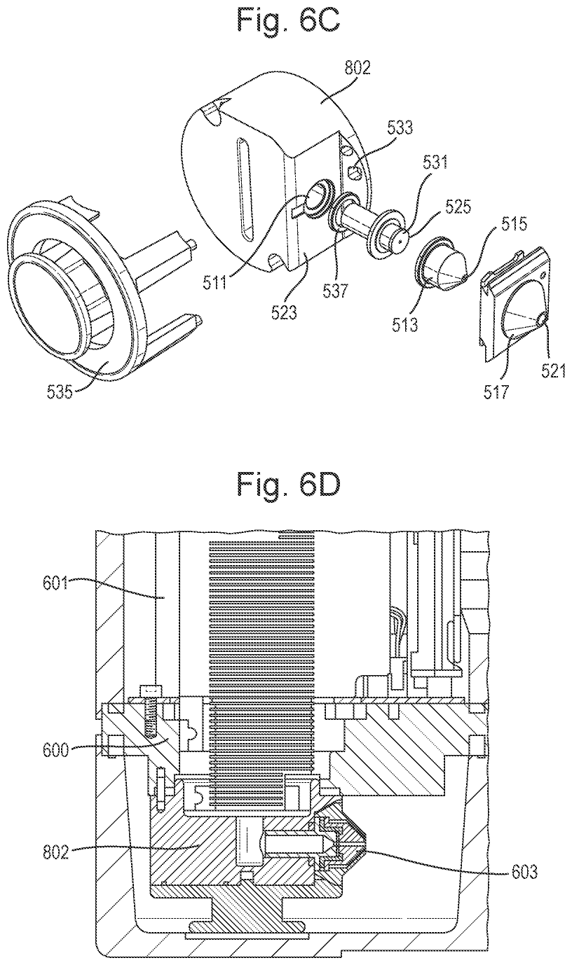

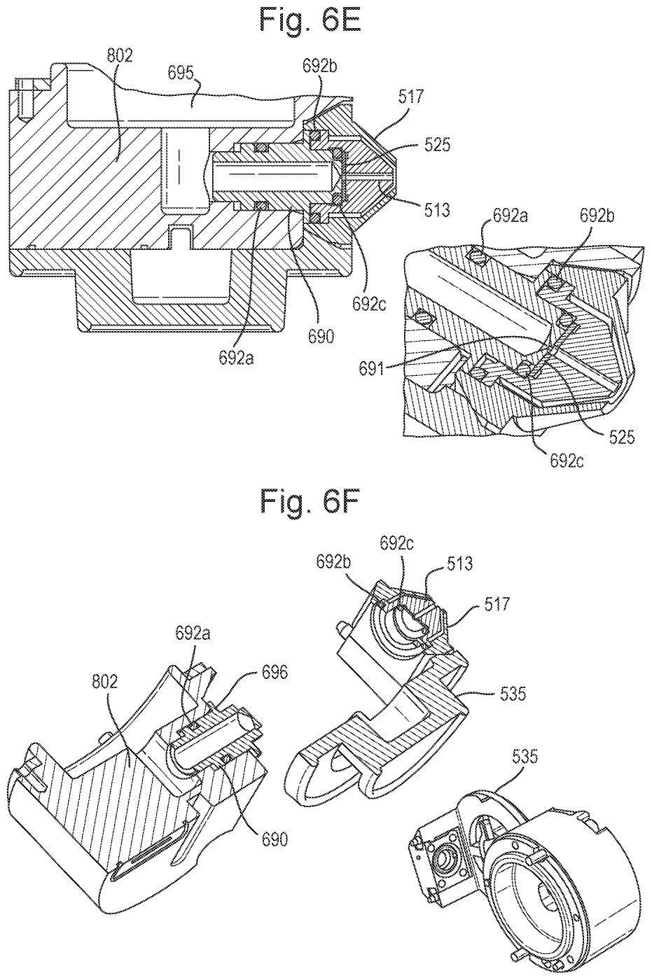

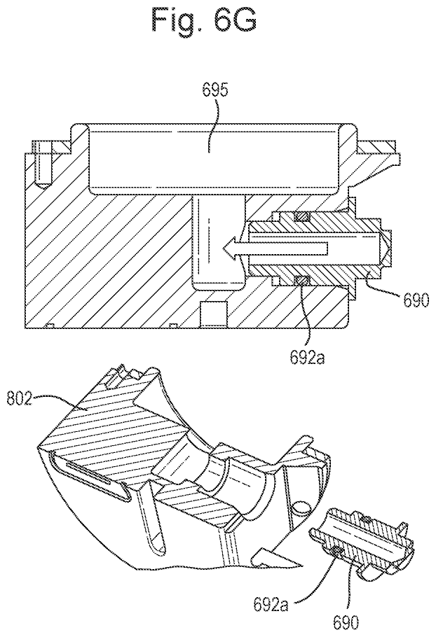

The initial stage of the associated mass spectrometer 100 comprises an ion block 802 (as shown in FIG. 6C) and a source enclosure may be provided if an Electrospray Ionisation ion source 300 is provided.

If a Desorption Electrospray Ionisation (“DESI”) ion source is provided then the ion source may comprise a DESI source, a DESI sprayer and an associated DESI power supply. The initial stage of the associated mass spectrometer may comprise an ion block 802 as shown in more detail in FIG. 6C. However, according to various embodiments if a DESI source is provided then the ion block 802 may not enclosed by a source enclosure.

It will be understood that a REIMS source involves the transfer of analyte, smoke, fumes, liquid, gas, surgical smoke, aerosol or vapour produced from a sample which may comprise a tissue sample. In some embodiments, the REIMS source may be arranged and adapted to aspirate the analyte, smoke, fumes, liquid, gas, surgical smoke, aerosol or vapour in a substantially pulsed manner. The REIMS source may be arranged and adapted to aspirate the analyte, smoke, fumes, liquid, gas, surgical smoke, aerosol or vapour substantially only when an electrosurgical cutting applied voltage or potential is supplied to one or more electrodes, one or more electrosurgical tips or one or more laser or other cutting devices.

The mass spectrometer 100 may be arranged so as to be capable of obtaining ion images of a sample. For example, according to various embodiments mass spectral and/or other physico-chemical data may be obtained as a function of position across a portion of a sample. Accordingly, a determination can be made as to how the nature of the sample may vary as a function of position along, across or within the sample.

The mass spectrometer 100 may comprise a first ion guide 301 such as a StepWave® ion guide 301 having a plurality of ring and conjoined ring electrodes. The mass spectrometer 100 may further comprise a segmented quadrupole rod set ion guide 302, one or more transfer lenses 303 and a Time of Flight mass analyser 304. The quadrupole rod set ion guide 302 may be operated in an ion guiding mode of operation and/or in a mass filtering mode of operation. The Time of Flight mass analyser 304 may comprise a linear acceleration Time of Flight region or an orthogonal acceleration Time of Flight mass analyser.

If the Time of Flight mass analyser comprises an orthogonal acceleration Time of Flight mass analyser 304 then the mass analyser 304 may comprise a pusher electrode 305, a reflectron 306 and an ion detector 307. The ion detector 307 may be arranged to detect ions which have been reflected by the reflectron 306. It should be understood, however, that the provision of a reflectron 306 though desirable is not essential.

According to various embodiments the first ion guide 301 may be provided downstream of an atmospheric pressure interface. The atmospheric pressure interface may comprise an ion inlet assembly.

The first ion guide 301 may be located in a first vacuum chamber or first differential pumping region.

The first ion guide 301 may comprise a part ring, part conjoined ring ion guide assembly wherein ions may be transferred in a generally radial direction from a first ion path formed within a first plurality of ring or conjoined ring electrodes into a second ion path formed by a second plurality of ring or conjoined ring electrodes. The first and second plurality of ring electrodes may be conjoined along at least a portion of their length. Ions may be radially confined within the first and second plurality of ring electrodes.

The second ion path may be aligned with a differential pumping aperture which may lead into a second vacuum chamber or second differential pumping region.

The first ion guide 301 may be utilised to separate charged analyte ions from unwanted neutral particles. The unwanted neutral particles may be arranged to flow towards an exhaust port whereas analyte ions are directed on to a different flow path and are arranged to be optimally transmitted through a differential pumping aperture into an adjacent downstream vacuum chamber.

It is also contemplated that according to various embodiments ions may in a mode of operation be fragmented within the first ion guide 301. In particular, the mass spectrometer 100 may be operated in a mode of operation wherein the gas pressure in the vacuum chamber housing the first ion guide 301 is maintained such that when a voltage supply causes ions to be accelerated into or along the first ion guide 301 then the ions may be arranged to collide with background gas in the vacuum chamber and to fragment to form fragment, daughter or product ions. According to various embodiments a static DC voltage gradient may be maintained along at least a portion of the first ion guide 301 in order to urge ions along and through the first ion guide 301 and optionally to cause ions in a mode of operation to fragment.

However, it should be understood that it is not essential that the mass spectrometer 100 is arranged so as to be capable of performing ion fragmentation in the first ion guide 301 in a mode of operation.

The mass spectrometer 100 may comprise a second ion guide 302 downstream of the first ion guide 302 and the second ion guide 302 may be located in the second vacuum chamber or second differential pumping region.

The second ion guide 302 may comprise a segmented quadrupole rod set ion guide or mass filter 302. However, other embodiments are contemplated wherein the second ion guide 302 may comprise a quadrupole ion guide, a hexapole ion guide, an octopole ion guide, a multipole ion guide, a segmented multipole ion guide, an ion funnel ion guide, an ion tunnel ion guide (e.g. comprising a plurality of ring electrodes each having an aperture through which ions may pass or otherwise forming an ion guiding region) or a conjoined ring ion guide.

The mass spectrometer 100 may comprise one or more transfer lenses 303 located downstream of the second ion guide 302. One of more of the transfer lenses 303 may be located in a third vacuum chamber or third differential pumping region. Ions may be passed through a further differential pumping aperture into a fourth vacuum chamber or fourth differential pumping region. One or more transfer lenses 303 may also be located in the fourth vacuum chamber or fourth differential pumping region.

The mass spectrometer 100 may comprise a mass analyser 304 located downstream of the one or more transfer lenses 303 and may be located, for example, in the fourth or further vacuum chamber or fourth or further differential pumping region. The mass analyser 304 may comprise a Time of Flight (“TOF”) mass analyser. The Time of Flight mass analyser 304 may comprise a linear or an orthogonal acceleration Time of Flight mass analyser.

According to various embodiments an orthogonal acceleration Time of Flight mass analyser 304 may be provided comprising one or more orthogonal acceleration pusher electrode(s) 305 (or alternatively and/or additionally one or more puller electrode(s)) and an ion detector 307 separated by a field free drift region. The Time of Flight mass analyser 304 may optionally comprise one or more reflectrons 306 intermediate the pusher electrode 305 and the ion detector 307.

Although highly desirable, it should be recognised that the mass analyser does not have to comprise a Time of Flight mass analyser 304. More generally, the mass analyser 304 may comprise either: (i) a quadrupole mass analyser; (ii) a 2D or linear quadrupole mass analyser; (iii) a Paul or 3D quadrupole mass analyser; (iv) a Penning trap mass analyser; (v) an ion trap mass analyser; (vi) a magnetic sector mass analyser; (vii) Ion Cyclotron Resonance (“ICR”) mass analyser; (viii) a Fourier Transform Ion Cyclotron Resonance (“FTICR”) mass analyser; (ix) an electrostatic mass analyser arranged to generate an electrostatic field having a quadro-logarithmic potential distribution; (x) a Fourier Transform electrostatic mass analyser; (xi) a Fourier Transform mass analyser; (xii) a Time of Flight mass analyser; (xiii) an orthogonal acceleration Time of Flight mass analyser; or (xiv) a linear acceleration Time of Flight mass analyser.

Although not shown in FIG. 3, the mass spectrometer 100 may also comprise one or more optional further devices or stages. For example, according to various embodiments the mass spectrometer 100 may additionally comprise one or more ion mobility separation devices and/or one or more Field Asymmetric Ion Mobility Spectrometer (“FAIMS”) devices and/or one or more devices for separating ions temporally and/or spatially according to one or more physico-chemical properties. For example, the mass spectrometer 100 according to various embodiments may comprise one or more separation stages for temporally or otherwise separating ions according to their mass, collision cross section, conformation, ion mobility, differential ion mobility or another physico-chemical parameter.

The mass spectrometer 100 may comprise one or more discrete ion traps or one or more ion trapping regions. However, as will be described in more detail below, an axial trapping voltage may be applied to one or more sections or one or more electrodes of either the first ion guide 301 and/or the second ion guide 302 in order to confine ions axially for a short period of time. For example, ions may be trapped or confined axially for a period of time and then released. The ions may be released in a synchronised manner with a downstream ion optical component. For example, in order to enhance the duty cycle of analyte ions of interest, an axial trapping voltage may be applied to the last electrode or stage of the second ion guide 302. The axial trapping voltage may then be removed and the application of a voltage pulse to the pusher electrode 305 of the Time of Flight mass analyser 304 may be synchronised with the pulsed release of ions so as to increase the duty cycle of analyte ions of interest which are then subsequently mass analysed by the mass analyser 304. This approach may be referred to as an Enhanced Duty Cycle (“EDC”) mode of operation.

Furthermore, the mass spectrometer 100 may comprise one or more collision, fragmentation or reaction cells selected from the group consisting of: (i) a Collisional Induced Dissociation (“CID”) fragmentation device; (ii) a Surface Induced Dissociation (“SID”) fragmentation device; (iii) an Electron Transfer Dissociation (“ETD”) fragmentation device; (iv) an Electron Capture Dissociation (“ECD”) fragmentation device; (v) an Electron Collision or Impact Dissociation fragmentation device; (vi) a Photo Induced Dissociation (“PID”) fragmentation device; (vii) a Laser Induced Dissociation fragmentation device; (viii) an infrared radiation induced dissociation device; (ix) an ultraviolet radiation induced dissociation device; (x) a nozzle-skimmer interface fragmentation device; (xi) an in-source fragmentation device; (xii) an in-source Collision Induced Dissociation fragmentation device; (xiii) a thermal or temperature source fragmentation device; (xiv) an electric field induced fragmentation device; (xv) a magnetic field induced fragmentation device; (xvi) an enzyme digestion or enzyme degradation fragmentation device; (xvii) an ion-ion reaction fragmentation device; (xviii) an ion-molecule reaction fragmentation device; (xix) an ion-atom reaction fragmentation device; (xx) an ion-metastable ion reaction fragmentation device; (xxi) an ion-metastable molecule reaction fragmentation device; (xxii) an ion-metastable atom reaction fragmentation device; (xxiii) an ion-ion reaction device for reacting ions to form adduct or product ions; (xxiv) an ion-molecule reaction device for reacting ions to form adduct or product ions; (xxv) an ion-atom reaction device for reacting ions to form adduct or product ions; (xxvi) an ion-metastable ion reaction device for reacting ions to form adduct or product ions; (xxvii) an ion-metastable molecule reaction device for reacting ions to form adduct or product ions; (xxviii) an ion-metastable atom reaction device for reacting ions to form adduct or product ions; and (xxix) an Electron Ionisation Dissociation (“EID”) fragmentation device.

The mass spectrometer 100 may comprise one or more mass filters selected from the group consisting of: (i) a quadrupole mass filter; (ii) a 2D or linear quadrupole ion trap; (iii) a Paul or 3D quadrupole ion trap; (iv) a Penning ion trap; (v) an ion trap; (vi) a magnetic sector mass filter; (vii) a Time of Flight mass filter; and (viii) a Wien filter.

The fourth or further vacuum chamber or fourth or further differential pumping region may be maintained at a lower pressure than the third vacuum chamber or third differential pumping region. The third vacuum chamber or third differential pumping region may be maintained at a lower pressure than the second vacuum chamber or second differential pumping region and the second vacuum chamber or second differential pumping region may be maintained at a lower pressure than the first vacuum chamber or first differential pumping region. The first vacuum chamber or first differential pumping region may be maintained at lower pressure than ambient. Ambient pressure may be considered to be approx. 1013 mbar at sea level.

The mass spectrometer 100 may comprise an ion source configured to generate analyte ions. In various particular embodiments, the ion source may comprise an Atmospheric Pressure Ionisation (“API”) ion source such as an Electrospray Ionisation (“ESI”) ion source or an Atmospheric Pressure Chemical Ionisation (“APCI”) ion source.

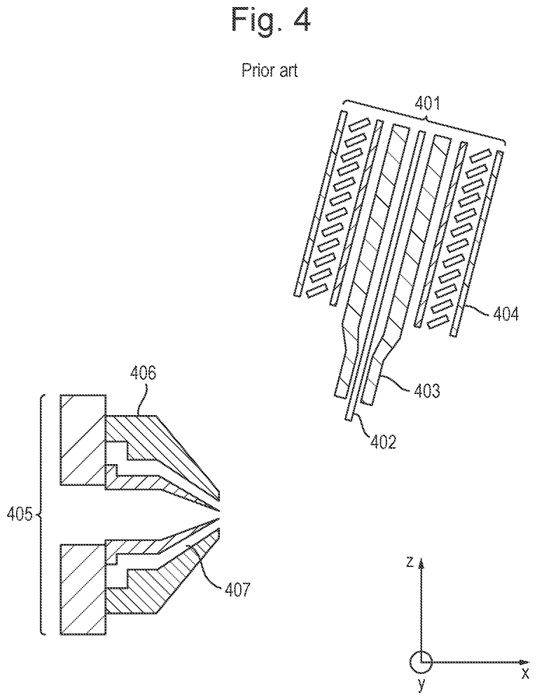

FIG. 4 shows in general form a known Atmospheric Pressure Ionisation (“API”) ion source such as an Electrospray Ionisation (“ESI”) ion source or an Atmospheric Pressure Chemical Ionisation (“APCI”) ion source. The ion source may comprise, for example, an Electrospray Ionisation probe 401 which may comprise an inner capillary tube 402 through which an analyte liquid may be supplied. The analyte liquid may comprise mobile phase from a LC column or an infusion pump. The analyte liquid enters via the inner capillary tube 402 or probe and is pneumatically converted to an electrostatically charged aerosol spray. Solvent is evaporated from the spray by means of heated desolvation gas. Desolvation gas may be provided through an annulus which surrounds both the inner capillary tube 402 and an intermediate surrounding nebuliser tube 403 through which a nebuliser gas emerges. The desolvation gas may be heated by an annular electrical desolvation heater 404. The resulting analyte and solvent ions are then directed towards a sample or sampling cone aperture mounted into an ion block 405 forming an initial stage of the mass spectrometer 100.

The inner capillary tube 402 is preferably surrounded by a nebuliser tube 403. The emitting end of the inner capillary tube 402 may protrude beyond the nebuliser tube 403. The inner capillary tube 402 and the nebuliser tube 403 may be surrounded by a desolvation heater arrangement 404 as shown in FIG. 4 wherein the desolvation heater 404 may be arranged to heat a desolvation gas. The desolvation heater 404 may be arranged to heat a desolvation gas from ambient temperature up to a temperature of around 600° C. According to various embodiments the desolvation heater 404 is always OFF when the API gas is OFF.

The desolvation gas and the nebuliser gas may comprise nitrogen, air or another gas or mixture of gases. The same gas (e.g. nitrogen, air or another gas or mixture of gases) may be used as both a desolvation gas, nebuliser gas and cone gas. The function of the cone gas will be described in more detail below.

The inner probe capillary 402 may be readily replaced by an unskilled user without needing to use any tools. The Electrospray probe 402 may support LC flow rates in the range of 0.3 to 1.0 mL/min.

According to various embodiments an optical detector may be used in series with the mass spectrometer 100. It will be understood that an optical detector may have a maximum pressure capability of approx. 1000 psi. Accordingly, the Electrospray Ionisation probe 401 may be arranged so as not to cause a back pressure of greater than around 500 psi, allowing for back pressure caused by other system components. The instrument may be arranged so that a flow of 50:50 methanol/water at 1.0 mL/min does not create a backpressure greater than 500 psi.

According to various embodiments a nebuliser flow rate of between 106 to 159 L/hour may be utilised.

The ESI probe 401 may be powered by a power supply which may have an operating range of 0.3 to 1.5 kV.

It should, however, be understood that various other different types of ion source may instead be coupled to the mass spectrometer 100. For example, according to various embodiments, the ion source may more generally comprise either: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“CI”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; (xvi) a Nickel-63 radioactive ion source; (xvii) an Atmospheric Pressure Matrix Assisted Laser Desorption Ionisation ion source; (xviii) a Thermospray ion source; (xix) an Atmospheric Sampling Glow Discharge Ionisation (“ASGDI”) ion source; (xx) a Glow Discharge (“GD”) ion source; (xxi) an Impactor ion source; (xxii) a Direct Analysis in Real Time (“DART”) ion source; (xxiii) a Laserspray Ionisation (“LSI”) ion source; (xxiv) a Sonicspray Ionisation (“SSI”) ion source; (xxv) a Matrix Assisted Inlet Ionisation (“MAII”) ion source; (xxvi) a Solvent Assisted Inlet Ionisation (“SAII”) ion source; (xxvii) a Desorption Electrospray Ionisation (“DESI”) ion source; (xxviii) a Laser Ablation Electrospray Ionisation (“LAESI”) ion source; (xxix) a Surface Assisted Laser Desorption Ionisation (“SALDI”) ion source; or (xxx) a Low Temperature Plasma (“LTP”) ion source.

A chromatography or other separation device may be provided upstream of the ion source 300 and may be coupled so as to provide an effluent to the ion source 300. The chromatography separation device may comprise a liquid chromatography or gas chromatography device. Alternatively, the separation device may comprise: (i) a Capillary Electrophoresis (“CE”) separation device; (ii) a Capillary Electrochromatography (“CEC”) separation device; (iii) a substantially rigid ceramic-based multilayer microfluidic substrate (“ceramic tile”) separation device; or (iv) a supercritical fluid chromatography separation device.

The mass spectrometer 100 may comprise an atmospheric pressure interface or ion inlet assembly downstream of the ion source 300. According to various embodiments the atmospheric pressure interface may comprise a sample or sampling cone 406,407 which is located downstream of the ion source 401. Analyte ions generated by the ion source 401 may pass via the sample or sampling cone 406,407 into or onwards towards a first vacuum chamber or first differential pumping region of the mass spectrometer 100. However, according to other embodiments the atmospheric pressure interface may comprise a capillary interface.

As shown in FIG. 4, ions generated by the ion source 401 may be directed towards an atmospheric pressure interface which may comprise an outer gas cone 406 and an inner sample cone 407. A cone gas may be supplied to an annular region between the inner sample cone 407 and the outer gas cone 406. The cone gas may emerge from the annulus in a direction which is generally opposed to the direction of ion travel into the mass spectrometer 100. The cone gas may act as a declustering gas which effectively pushes away large contaminants thereby preventing large contaminants from impacting upon the outer cone 406 and/or inner cone 407 and also preventing the large contaminants from entering into the initial vacuum stage of the mass spectrometer 100.

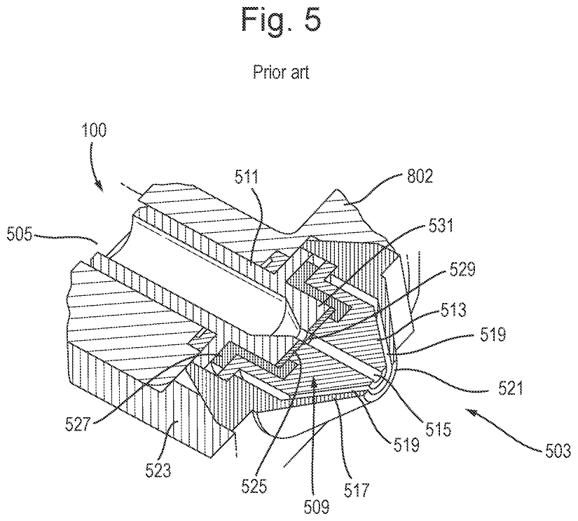

FIG. 5 shows in more detail a first known ion inlet assembly which is similar to an ion inlet assembly according to various embodiments. The known ion inlet assembly as shown and described below with reference to FIGS. 5 and 6A is presented in order to highlight various aspects of an ion inlet assembly according to various embodiments and also so that differences between an ion inlet assembly according to various embodiments as shown and discussed below with reference to FIG. 6C can be fully appreciated.

With reference to FIG. 5, it will be understood that the ion source (not shown) generates analyte ions which are directed towards a vacuum chamber 505 of the mass spectrometer 100.

A gas cone assembly is provided comprising an inner gas cone or sampling cone 513 having an aperture 515 and an outer gas cone 517 having an aperture 521. A disposable disc 525 is arranged beneath or downstream of the inner gas cone or sampling 513 and is held in position by a mounting element 527. The disc 525 covers an aperture 511 of the vacuum chamber 505. The disc 525 is removably held in position by the inner gas cone 513 resting upon the mounting element 527.

As will be discussed in more detail below with reference to FIG. 6C, according to various embodiments the mounting element 527 is not provided in the preferred ion inlet assembly.

The disc 525 has an aperture or sampling orifice 529 through which ions can pass.

A carrier 531 is arranged underneath or below the disc 525. The carrier 531 is arranged to cover the aperture 511 of the vacuum chamber 505. Upon removal of the disc 525, the carrier 531 may remain in place due to suction pressure.

FIG. 6A shows an exploded view of the first known ion inlet assembly. The outer gas cone 517 has a cone aperture 521 and is slidably mounted within a clamp 535. The clamp 535 allows a user to remove the outer gas cone 517 without physically having to touch the outer gas cone 517 which will get hot during use.

An inner gas cone or sampling cone 513 is shown mounted behind or below the outer gas cone 517.

The known arrangement utilises a carrier 531 which has a 1 mm diameter aperture. The ion block 802 is also shown having a calibration port 550. However, the calibration port 550 is not provided in an ion inlet assembly according to various embodiments.

FIG. 6B shows an second different known ion inlet assembly as used on a different instrument which has an isolation valve 560 which is required to hold vacuum pressure when the outer cone gas nozzle 517 and the inner nozzle 513 are removed for servicing. The inner cone 513 has a gas limiting orifice into the subsequent stages of the mass spectrometer. The inner gas cone 513 comprises a high cost, highly precisioned part which requires routine removal and cleaning. The inner gas cone 513 is not a disposable or consumable item. Prior to removing the inner sampling cone 513 the isolation valve 560 must be rotated into a closed position in order to isolate the downstream vacuum stages of the mass spectrometer from atmospheric pressure. The isolation valve 560 is therefore required in order to hold vacuum pressure whilst the inner gas sampling cone 513 is removed for cleaning.

FIG. 6C shows an exploded view of an ion inlet assembly according to various embodiments. The ion inlet assembly according to various embodiments is generally similar to the first known ion inlet assembly as shown and described above with reference to FIGS. 5 and 6A except for a few differences. One difference is that a calibration port 550 is not provided in the ion block 802 and a mounting member or mounting element 527 is not provided.

Accordingly, the ion block 802 and ion inlet assembly have been simplified. Furthermore, importantly the disc 525 may comprise a 0.25 or 0.30 mm diameter aperture disc 525 which is substantially smaller diameter than conventional arrangements.

According to various embodiments both the disc 525 and the vacuum holding member or carrier 531 may have a substantially smaller diameter aperture than conventional arrangements such as the first known arrangement as shown and described above with reference to FIGS. 5 and 6A.

For example, the first known instrument utilises a vacuum holding member or carrier 531 which has a 1 mm diameter aperture. In contrast, according to various embodiments the vacuum holding member or carrier 531 according to various embodiments may have a much smaller diameter aperture e.g. a 0.3 mm or 0.40 mm diameter aperture.

FIG. 6D shows in more detail how the ion block assembly 802 according to various embodiments may be enclosed in an atmospheric pressure source or housing. The ion block assembly 802 may be mounted to a pumping block or thermal interface 600. Ions pass through the ion block assembly 802 and then through the pumping block or thermal interface 600 into a first vacuum chamber 601 of the mass spectrometer 100. The first vacuum chamber 601 preferably houses the first ion guide 301 which as shown in FIG. 6D and which may comprise a conjoined ring ion guide 301. FIG. 6D also indicates how ion entry 603 into the mass spectrometer 100 also represents a potential leak path. A correct pressure balance is required between the diameters of the various gas flow restriction apertures in the ion inlet assembly with the configuration of the vacuum pumping system.

FIG. 6E shows the ion inlet assembly according to various embodiments and illustrates how ions pass through an outer gas cone 517 and an inner gas cone or sampling cone 513 before passing through an apertured disc 525. No mounting member or mounting element is provided unlike the first known ion inlet assembly as described above.

The ions then pass through an aperture in a fixed valve 690. The fixed valve 690 is held in place by suction pressure and is not removable by a user in normal operation. Three O-ring vacuum seals 692a,692b,692c are shown. The fixed valve 690 may be formed from stainless steel. A vacuum region 695 of the mass spectrometer 100 is generally indicated.

FIG. 6F shows the outer cone 517, inner sampling cone 513 and apertured disc 525 having been removed by a user by withdrawing or removing a clamp 535 to which at least the outer cone 517 is slidably inserted. According to various embodiments the inner sampling cone 513 may also be attached or secured to the outer cone 517 so that both are removed at the same time.

Instead of utilising a conventional rotatable isolation valve, a fixed non-rotatable valve 690 is provided or otherwise retained in the ion block 802. An O-ring seal 692a is shown which ensures that a vacuum seal is provided between the exterior body of the fixed valve 690 and the ion block 802. An ion block voltage contact 696 is also shown. O-rings seals 692b,692c for the inner and outer cones 513,517 are also shown.

FIG. 6G illustrates how according to various embodiments a fixed valve 690 may be retained within an ion block 802 and may form a gas tight sealing therewith by virtue of an O-ring seal 692a. A user is unable to remove the fixed valve 690 from the ion block 802 when the instrument is operated due to the vacuum pressure within the vacuum chamber 695 of the instrument. The direction of suction force which holds the fixed valve 690 in a fixed position against the ion block 802 during normal operation is shown.

The size of the entrance aperture into the fixed valve 690 is designed for optimum operation conditions and component reliability. Various embodiments are contemplated wherein the shape of the entrance aperture may be cylindrical. However, other embodiments are contemplated wherein there may be more than one entrance aperture and/or wherein the one or more entrance apertures to the fixed valve 690 may have a non-circular aperture. Embodiments are also contemplated wherein the one or more entrance apertures may be angled at a non-zero angle to the longitudinal axis of the fixed valve 690.

It will be understood that total removal of the fixed valve 690 from the ion block 802 will rapidly result in total loss of vacuum pressure within the mass spectrometer 100.

According to various embodiments the ion inlet assembly may be temporarily sealed in order to allow a vacuum housing within the mass spectrometer 100 to be filled with dry nitrogen for shipping. It will be appreciated that filling a vacuum chamber with dry nitrogen allows faster initial pump-down during user initial instrument installation.

It will be appreciated that since according to various embodiments the internal aperture in the vacuum holding member or carrier 531 is substantially smaller in diameter than conventional arrangements, then the vacuum within the first and subsequent vacuum chambers of the instrument can be maintained for substantially longer periods of time than is possible conventionally when the disc 525 is removed and/or replaced.

Accordingly, the mass spectrometer 100 according to various embodiments does not require an isolation valve in contrast with other known mass spectrometers in order to maintain the vacuum within the instrument when a component such as the outer gas cone 517, the inner gas cone 513 or the disc 525 are removed.

A mass spectrometer 100 according to various embodiments therefore enables a reduced cost instrument to be provided which is also simpler for a user to operate since no isolation valve is needed. Furthermore, a user does not need to be understand or learn how to operate such an isolation valve.

The ion block assembly 802 may comprise a heater in order to keep the ion block 802 above ambient temperature in order to prevent droplets of analyte, solvent, neutral particles or condensation from forming within the ion block 802.

According to an embodiment when a user wishes to replace and/or remove either the outer cone 517 and/or the inner sampling cone 513 and/or the disc 525 then both the source or ion block heater and the desolvation heater 404 may be turned OFF. The temperature of the ion block 802 may be monitored by a thermocouple which may be provided within the ion block heater or which may be otherwise provided in or adjacent to the ion block 802.

When the temperature of the ion block is determined to have dropped below a certain temperature such as e.g. 55° C. then the user may be informed that the clamp 535, outer gas cone 517, inner gas sampling cone 513 and disc 525 are sufficiently cooled down such that a user can touch them without serious risk of injury.

According to various embodiment a user can simply remove and/or replace the outer gas cone 517 and/or inner gas sampling cone 513 and/or disc 525 in less than two minutes without needing to vent the instrument. In particular, the low pressure within the instrument is maintained for a sufficient period of time by the aperture in the fixed valve 690.

According to various embodiments the instrument may be arranged so that the maximum leak rate into the source or ion block 802 during sample cone maintenance is approx. 7 mbar L/s. For example, assuming a backing pump speed of 9 m³/hour (2.5 L/s) and a maximum acceptable pressure of 3 mbar, then the maximum leak rate during sampling cone maintenance may be approx. 2.5 L/s×3 mbar=7.5 mbar L/s.

The ion block 802 may comprise an ion block heater having a K-type thermistor. As will be described in more detail below, according to various embodiments the source (ion block) heater may be disabled to allow forced cooling of the source or ion block 802. For example, desolvation heater 404 and/or ion block heater may be switched OFF whilst API gas is supplied to the ion block 802 in order to cool it down. According to various embodiments either a desolvation gas flow and/or a nebuliser gas flow from the probe 401 may be directed towards the cone region 517,513 of the ion block 802. Additionally and/or alternatively, the cone gas supply may be used to cool the ion block 802 and the inner and outer cones 513,517. In particular, by turning the desolvation heater 404 OFF but maintaining a supply of nebuliser and/or desolvation gas from the probe 401 so as to fill the enclosure housing the ion block with ambient temperature nitrogen or other gas will have a rapid cooling effect upon the metal and plastic components forming the ion inlet assembly which may be touched by a user during servicing. Ambient temperature (e.g. in the range 18-25° C.) cone gas may also be supplied in order to assist with cooling the ion inlet assembly in a rapid manner. Conventional instruments do not have the functionality to induce rapid cooling of the ion block 802 and gas cones 521,513.

Liquid and gaseous exhaust from the source enclosure may be fed into a trap bottle. The drain tubing may be routed so as to avoid electronic components and wiring. The instrument may be arranged so that liquid in the source enclosure always drains out even when the instrument is switched OFF. For example, it will be understood that an LC flow into the source enclosure could be present at any time.

An exhaust check valve may be provided so that when the API gas is turned OFF the exhaust check valve prevents a vacuum from forming in the source enclosure and trap bottle. The exhaust trap bottle may have a capacity≥5 L.

The fluidics system may comprise a piston pump which allows the automated introduction of a set-up solution into the ion source. The piston pump may have a flow rate range of 0.4 to 50 mL/min. A divert/select valve may be provided which allows rapid automated changeover between LC flow and the flow of one or two internal set-up solutions into the source.

According to various embodiments three solvent bottles 201 may be provided. Solvent A bottle may have a capacity within the range 250-300 mL, solvent B bottle may have a capacity within the range 50-60 mL and solvent C bottle may have a capacity within the range 100-125 mL. The solvent bottles 201 may be readily observable by a user who may easily refill the solvent bottles.

According to an embodiment solvent A may comprise a lock-mass, solvent B may comprise a calibrant and solvent C may comprise a wash. Solvent C (wash) may be connected to a rinse port.

A driver PCB may be provided in order to control the piston pump and the divert/select valve. On power-up the piston pump may be homed and various purge parameters may be set.

Fluidics may be controlled by software and may be enabled as a function of the instrument state and the API gas valve state in a manner as detailed below:

| | | Software control of |
|---|---|---|
| Instrument state | API gas valve | fluidics |
| Operate | Open | Enabled |
| Operate | Closed | Disabled |
| Over-pressure | Open | Enabled |
| Over-pressure | Closed | Disabled |
| Power Save | Open | Disabled |
| Power Save | Closed | Disabled |

When software control of the fluidics is disabled then the valve is set to a divert position and the pump is stopped.

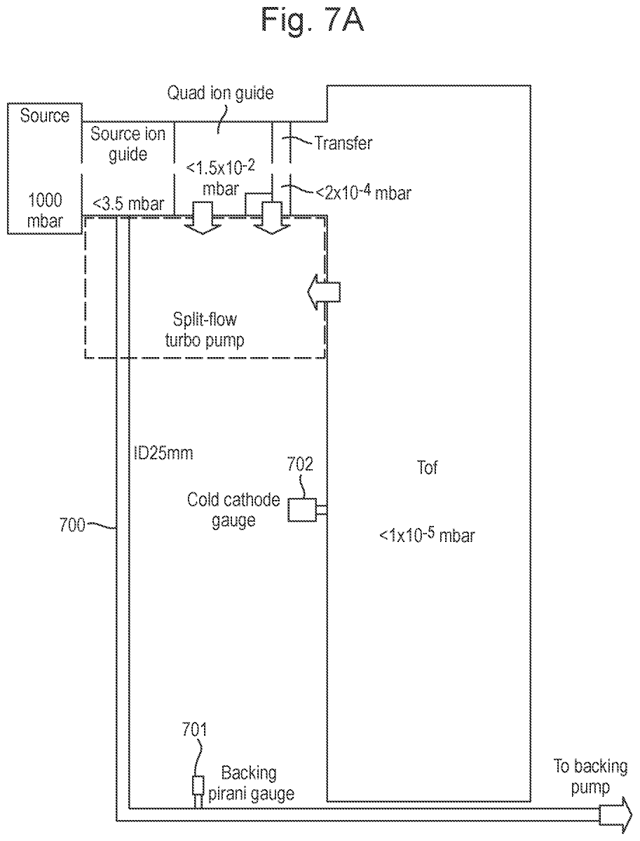

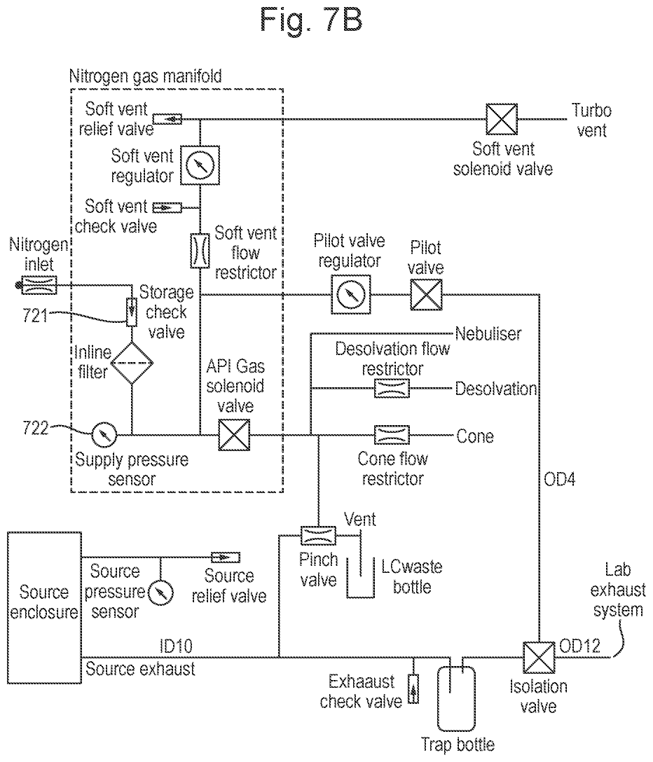

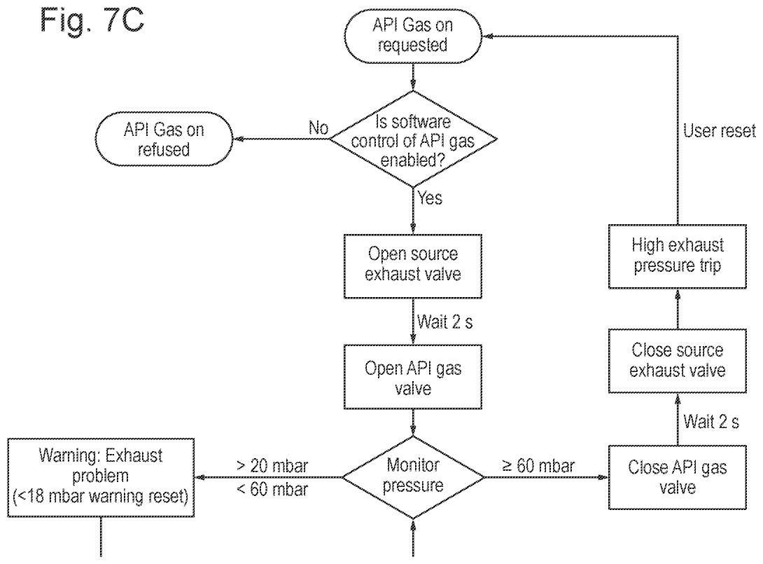

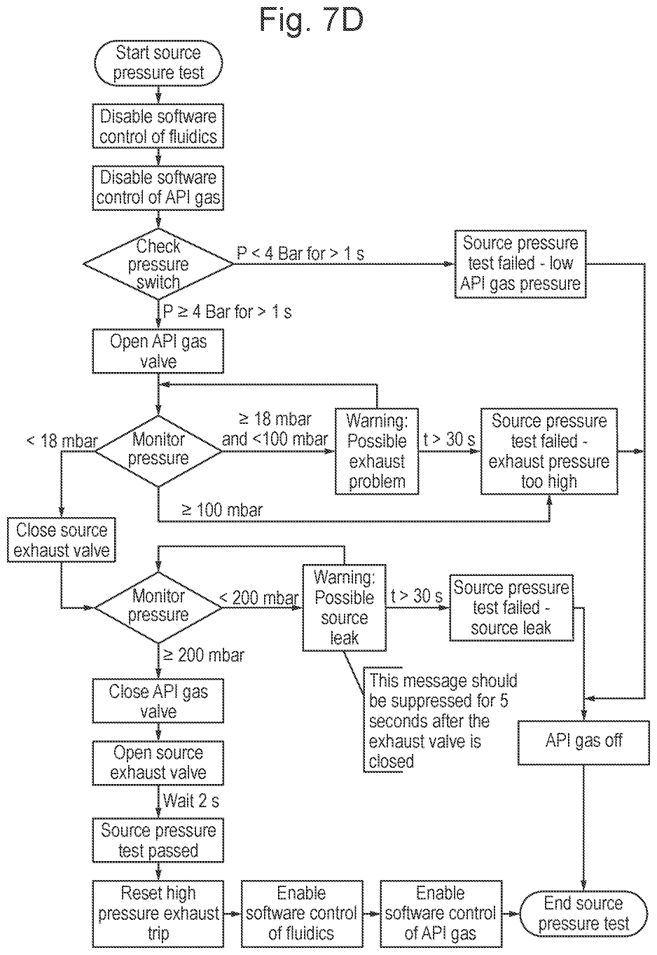

FIG. 7A illustrates a vacuum pumping arrangement according to various embodiments.

A split-flow turbo molecular vacuum pump (commonly referred to as a “turbo” pump) may be used to pump the fourth or further vacuum chamber or fourth or further differential pumping region, the third vacuum chamber or third differential pumping region, and the second vacuum chamber or second differential pumping region. According to an embodiment the turbo pump may comprise either a Pfeiffer® Splitflow 310 fitted with a TC110 controller or an Edwards® nEXT300/100/100D turbo pump. The turbo pump may be air cooled by a cooling fan.

The turbo molecular vacuum pump may be backed by a rough, roughing or backing pump such as a rotary vane vacuum pump or a diaphragm vacuum pump. The rough, roughing or backing pump may also be used to pump the first vacuum chamber housing the first ion guide 301. The rough, roughing or backing pump may comprise an Edwards® nRV14i backing pump. The backing pump may be provided external to the instrument and may be connected to the first vacuum chamber which houses the first ion guide 301 via a backing line 700 as shown in FIG. 7A.

A first pressure gauge such as a cold cathode gauge 702 may be arranged and adapted to monitor the pressure of the fourth or further vacuum chamber or fourth or further differential pumping region. According to an embodiment the Time of Flight housing pressure may be monitored by an Inficon® MAG500 cold cathode gauge 702.

A second pressure gauge such as a Pirani gauge 701 may be arranged and adapted to monitor the pressure of the backing pump line 700 and hence the first vacuum chamber which is in fluid communication with the upstream pumping block 600 and ion block 802. According to an embodiment the instrument backing pressure may be monitored by an Inficon® PSG500 Pirani gauge 701.

According to various embodiments the observed leak plus outgassing rate of the Time of Flight chamber may be arranged to be less than 4×10⁻⁵ mbar L/s. Assuming a 200 L/s effective turbo pumping speed then the allowable leak plus outgassing rate is 5×10⁻⁷ mbar×200 L/s=1×10⁻⁴ mbar L/s.

A turbo pump such as an Edwards® nEXT300/100/100D turbo pump may be used which has a main port pumping speed of 400 L/s. As will be detailed in more detail below, EMC shielding measures may reduce the pumping speed by approx. 20% so that the effective pumping speed is 320 L/s. Accordingly, the ultimate vacuum according to various embodiments may be 4×10⁻⁵ mbar L/s/320 L/s=1.25×10⁻⁷ mbar.

According to an embodiment a pump-down sequence may comprise closing a soft vent solenoid as shown in FIG. 7B, starting the backing pump and waiting until the backing pressure drops to 32 mbar. If 32 mbar is not reached within 3 minutes of starting the backing pump then a vent sequence may be performed. Assuming that a pressure of 32 mbar is reached within 3 minutes then the turbo pump is then started. When the turbo speed exceeds 80% of maximum speed then the Time of Flight vacuum gauge 702 may then be switched ON. It will be understood that the vacuum gauge 702 is a sensitive detector and hence is only switched ON when the vacuum pressure is such that the vacuum gauge 702 which not be damaged.

If the turbo speed does not reach 80% of maximum speed within 8 minutes then a vent sequence may be performed.

A pump-down sequence may be deemed completed once the Time of Flight vacuum chamber pressure is determined to be <1×10⁻⁵ mbar.

If a vent sequence is to be performed then the instrument may be switched to a Standby mode of operation. The Time of Flight vacuum gauge 702 may be switched OFF and the turbo pump may also be switched OFF. When the turbo pump speed falls to less than 80% of maximum then a soft vent solenoid valve as shown in FIG. 7B may be opened. The system may then wait for 10 seconds before then switching OFF the backing pump.

It will be understood by those skilled in the art that the purpose of the turbo soft vent solenoid valve as shown in FIG. 7B and the soft vent line is to enable the turbo pump to be vented at a controlled rate. It will be understood that if the turbo pump is vented at too fast a rate then the turbo pump may be damaged.

The instrument may switch into a maintenance mode of operation which allows an engineer to perform service work on all instrument sub-systems except for the vacuum system or a subsystem incorporating the vacuum system without having to vent the instrument. The instrument may be pumped down in maintenance mode and conversely the instrument may also be vented in maintenance mode.

A vacuum system protection mechanism may be provided wherein if the turbo speed falls to less than 80% of maximum speed then a vent sequence is initiated. Similarly, if the backing pressure increases to greater than 10 mbar then a vent sequence may also be initiated. According to an embodiment if the turbo power exceeds 120 W for more than 15 minutes then a vent sequence may also be initiated. If on instrument power-up the turbo pump speed is >80% of maximum then the instrument may be set to a pumped state, otherwise the instrument may be set to a venting state.

FIG. 7B shows a schematic of a gas handling system which may be utilised according to various embodiments. A storage check valve 721 may be provided which allows the instrument to be filled with nitrogen for storage and transport. The storage check valve 721 is in fluid communication with an inline filter.

A soft vent flow restrictor may be provided which may limit the maximum gas flow to less than the capacity of a soft vent relief valve in order to prevent the analyser pressure from exceeding 0.5 bar in a single fault condition. The soft vent flow restrictor may comprise an orifice having a diameter in the range 0.70 to 0.75 mm.

A supply pressure sensor 722 may be provided which may indicate if the nitrogen pressure has fallen below 4 bar.

An API gas solenoid valve may be provided which is normally closed and which has an aperture diameter of not less than 1.4 mm.

An API gas inlet is shown which preferably comprises a Nitrogen gas inlet. According to various embodiments the nebuliser gas, desolvation gas and cone gas are all supplied from a common source of nitrogen gas.

A soft vent regulator may be provided which may function to prevent the analyser pressure exceeding 0.5 bar in normal condition.

A soft vent check valve may be provided which may allow the instrument to vent to atmosphere in the event that the nitrogen supply is OFF.

A soft vent relief valve may be provided which may have a cracking pressure of 345 mbar. The soft vent relief valve may function to prevent the pressure in the analyser from exceeding 0.5 bar in a single fault condition. The gas flow rate through the soft vent relief valve may be arranged so as not to be less than 2000 L/h at a differential pressure of 0.5 bar.

The soft vent solenoid valve may normally be in an open position. The soft vent solenoid valve may be arranged to restrict the gas flow rate in order to allow venting of the turbo pump at 100% rotational speed without causing damage to the pump. The maximum orifice diameter may be 1.0 mm.

The maximum nitrogen flow may be restricted such that in the event of a catastrophic failure of the gas handling the maximum leak rate of nitrogen into the lab should be less than 20% of the maximum safe flow rate. According to various embodiments an orifice having a diameter of 1.4 to 1.45 mm may be used.

A source pressure sensor may be provided.

A source relief valve having a cracking pressure of 345 mbar may be provided. The source relief valve may be arranged to prevent the pressure in the source from exceeding 0.5 bar in a single fault condition. The gas flow rate through the source relief valve may be arranged so as not to be less than 2000 L/h at a differential pumping pressure of 0.5 bar. A suitable valve is a Ham-Let® H-480-S-G-1/4-5 psi valve.

A cone restrictor may be provided to restrict the cone flow rate to 36 L/hour for an input pressure of 7 bar. The cone restrictor may comprise a 0.114 mm orifice.

The desolvation flow may be restricted by a desolvation flow restrictor to a flow rate of 940 L/hour for an input pressure of 7 bar. The desolvation flow restrictor may comprise a 0.58 mm orifice.

A pinch valve may be provided which has a pilot operating pressure range of at least 4 to 7 bar gauge. The pinch valve may normally be open and may have a maximum inlet operating pressure of at least 0.5 bar gauge.

When the instrument is requested to turn the API gas OFF, then control software may close the API gas valve, wait 2 seconds and then close the source exhaust valve.

In the event of an API gas failure wherein the pressure switch opens (pressure<4 bar) then software control of the API gas may be disabled and the API gas valve may be closed. The system may then wait 2 seconds before closing the exhaust valve.

In order to turn the API gas ON a source pressure monitor may be turned ON except while a source pressure test is performed. An API gas ON or OFF request from software may be stored as an API Gas Request state which can either be ON or OFF. Further details are presented below:

| API Gas Request state | API Gas Control state | API gas valve |
|---|---|---|
| ON | Enabled | Open |
| ON | Disabled | Closed |
| OFF | Enabled | Closed |
| OFF | Disabled | Closed |

FIG. 7C shows a flow diagram showing an instrument response to a user request to turn the API gas ON. A determination may be made as to whether or not software control of API gas is enabled. If software control is not enabled then the request may be refused. If software control of API gas is enabled then the open source exhaust valve may be opened. Then after a delay of 2 seconds the API gas valve may be opened. The pressure is then monitored. If the pressure is determined to be between 20-60 mbar then a warning message may be communicated or issued. If the pressure is greater than 60 mbar then the API gas valve may be closed. Then after a delay of 2 seconds the source exhaust valve may be closed and a high exhaust pressure trip may occur.

A high exhaust pressure trip may be reset by running a source pressure test.

According to various embodiments the API gas valve may be closed within 100 ms of an excess pressure being sensed by the source pressure sensor.

FIG. 7D shows a flow diagram illustrating a source pressure test which may be performed according to various embodiments. The source pressure test may be commenced and software control of fluidics may be disabled so that no fluid flows into the Electrospray probe 401. Software control of the API gas may also be disabled i.e. the API is turned OFF. The pressure switch may then be checked. If the pressure is above 4 bar for more than 1 second then the API gas valve may be opened. However, if the pressure is less than 4 bar for more than 1 second then the source pressure test may move to a failed state due to low API gas pressure.

Assuming that the API gas valve is opened then the pressure may then be monitored. If the pressure is in the range 18-100 mbar then a warning message may be output indicating a possible exhaust problem. If the warning status continues for more than 30 seconds then the system may conclude that the source pressure test has failed due to the exhaust pressure being too high.

If the monitored pressure is determined to be less than 18 mbar then the source exhaust valve is closed.

The pressure may then again be monitored. If the pressure is less than 200 mbar then a warning message indicating a possible source leak may be issued.

If the pressure is determined to be greater than 200 mbar then the API gas valve may be closed and the source exhaust valve may be opened i.e. the system looks to build pressure and to test for leaks. The system may then wait 2 seconds before determining that the source pressure test is passed.

If the source pressure test has been determined to have been passed then the high pressure exhaust trip may be reset and software control of fluidics may be enabled. Software control of the API gas may then be enabled and the source pressure test may then be concluded.

According to various embodiments the API gas valve may be closed within 100 ms of an excess pressure being sensed by the source pressure sensor.

In the event of a source pressure test failure, the divert valve position may be set to divert and the valve may be kept in this position until the source pressure test is either passed or the test is over-ridden.

It is contemplated that the source pressure test may be over-ridden in certain circumstances. Accordingly, a user may be permitted to continue to use an instrument where they have assessed any potential risk as being acceptable. If the user is permitted to continue using the instrument then the source pressure test status message may still be displayed in order to show the original failure. As a result, a user may be reminded of the continuing failed status so that the user may continually re-evaluate any potential risk.

In the event that a user requests a source pressure test over-ride then the system may reset a high pressure exhaust trip and then enable software control of the divert valve. The system may then enable software control of the API gas before determining that the source pressure test over-ride is complete.

The pressure reading used in the source pressure test and source pressure monitoring may include a zero offset correction.

The gas and fluidics control responsibility may be summarised as detailed below:

| Mode of operation | Software | Electronics |
|---|---|---|
| Operate | Gas and fluidics | None |
| Power save | Gas | Fluidics |
| Standby | Gas | Fluidics |
| SPT/Failure | None | Gas and fluidics |
| Vacuum loss | None | Gas and fluidics |
| Gas fail state | None | Gas and fluidics |
| Operate gas OFF | Gas | Fluidics |

A pressure test may be initiated if a user triggers an interlock.

The instrument may operate in various different modes of operation. If the turbo pump speed falls to less than 80% of maximum speed whilst in Operate, Over-pressure or Power save mode then the instrument may enter a Standby state or mode of operation.

If the pressure in the Time of Flight vacuum chamber is greater than 1×10⁻⁵ mbar and/or the turbo speed is less than 80% of maximum speed then the instrument may be prevented from operating in an Operate mode of operation.

According to various embodiments the instrument may be operated in a Power save mode. In a Power save mode of operation the piston pump may be stopped. If the instrument is switched into a Power save mode while the divert valve is in the LC position, then the divert valve may change to a divert position. A Power save mode of operation may be considered as being a default mode of operation wherein all back voltages are kept ON, front voltages are turned OFF and gas is OFF.

If the instrument switches from a Power save mode of operation to an Operate mode of operation then the piston pump divert valves may be returned to their previous states i.e. their states immediately before a Power save mode of operation was entered.

If the Time of Flight region pressure rises above 1.5×10⁻⁵ mbar while the instrument is in an Operate mode of operation then the instrument may enter an Over-pressure mode of operation or state.

If the Time of Flight pressure enters the range 1×10⁻⁸ to 1×10⁻⁵ mbar while the instrument is in an Over-pressure mode of operation then the instrument may enter an Operate mode of operation.

If the API gas pressure falls below its trip level while the instrument is in an Operate mode of operation then the instrument may enter a Gas Fail state or mode of operation. The instrument may remain in a Gas Fail state until both: (i) the API gas pressure is above its trip level; and (ii) the instrument is operated in either Standby or Power save mode.

According to an embodiment the instrument may transition from an Operate mode of operation to an Operate with Source Interlock Open mode of operation when the source cover is opened. Similarly, the instrument may transition from an Operate with Source Interlock Open mode of operation to an Operate mode of operation when the source cover is closed.

According to an embodiment the instrument may transition from an Over-pressure mode of operation to an Over-pressure with Source Interlock Open mode of operation when the source cover is opened. Similarly, the instrument may transition from an Over-pressure with Source Interlock Open mode of operation to an Over-pressure mode of operation when the source cover is closed.

The instrument may operate in a number of different modes of operation which may be summarised as follows:

| | | | | | API gas |
|---|---|---|---|---|---|
| Mode of | Analyser | Front end | Desolvation | Source | control |
| operation | voltages | voltages | heater | heater | state |
| Standby | OFF | OFF | OFF | ON | Enabled |
| Operate | ON | ON | ON | ON | Enabled |
| Power Save | ON | OFF | OFF | ON | Enabled |
| Over- | OFF | ON | ON | ON | Enabled |
| pressure | | | | | |
| Gas Fail | ON | OFF | OFF | ON | Disabled |
| Operate | ON | OFF | OFF | OFF | Disabled |
| with Source | | | | | |
| Interlock | | | | | |
| Over- | OFF | OFF | OFF | OFF | Disabled |
| pressure | | | | | |
| with Source | | | | | |
| interlock | | | | | |
| Not | OFF | OFF | OFF | OFF | Enabled |
| Pumped | | | | | |

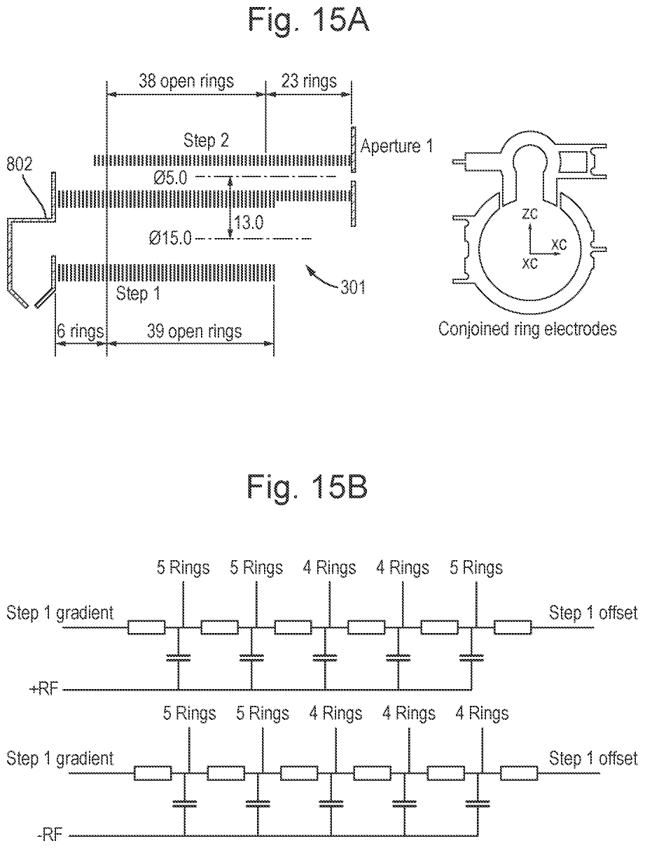

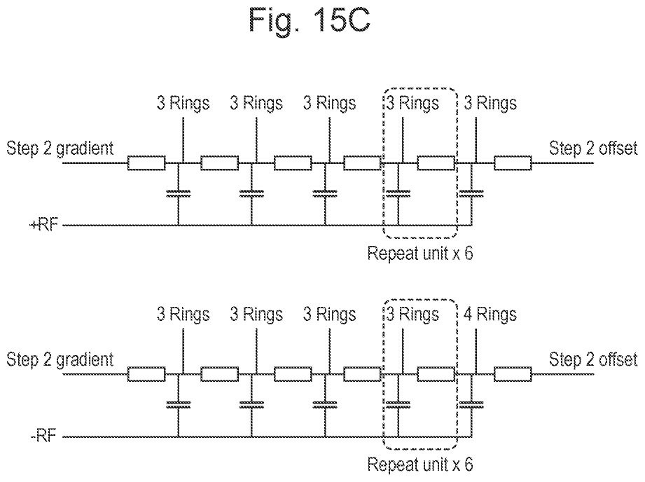

Reference to front end voltages relates to voltages which are applied to the Electrospray capillary electrode 402, the source offset, the source or first ion guide 301, aperture #1 (see FIG. 15A) and the quadrupole ion guide 302.

Reference to analyser voltages relates to all high voltages except the front end voltages.

Reference to API gas refers to desolvation, cone and nebuliser gases.

Reference to Not Pumped refers to all vacuum states except pumped.

If any high voltage power supply loses communication with the overall system or a global circuitry control module then the high voltage power supply may be arranged to switch OFF its high voltages. The global circuitry control module may be arranged to detect the loss of communication of any subsystem such as a power supply unit (“PSU”), a pump or gauge etc.

According to various embodiments the system will not indicate its state or mode of operation as being Standby if the system is unable to verify that all subsystems are in a Standby state.

As is apparent from the above table, when the instrument is operated in an Operate mode of operation then all voltages are switched ON. When the instrument transitions to operate in an Operate mode of operation then the following voltages are ON namely transfer lens voltages, ion guide voltages, voltages applied to the first ion guide 301 and the capillary electrode 402. In addition, the desolvation gas and desolvation heater are all ON.

If a serious fault were to develop then the instrument may switch to a Standby mode of operation wherein all voltages apart from the source heater provided in the ion block 802 are turned OFF and only a service engineer can resolve the fault. It will be understood that the instrument may only be put into a Standby mode of operation wherein voltages apart from the source heater in the ion block 802 are turned OFF only if a serious fault occurs or if a service engineer specifies that the instrument should be put into a Standby mode operation. A user or customer may (or may not) be able to place an instrument into a Standby mode of operation. Accordingly, in a Standby mode of operation all voltages are OFF and the desolvation gas flow and desolvation heater 404 are all OFF. Only the source heater in the ion block 802 may be left ON.

The instrument may be kept in a Power Save mode by default and may be switched so as to operate in an Operate mode of operation wherein all the relevant voltages and gas flows are turned ON. This approach significantly reduces the time taken for the instrument to be put into a useable state. When the instrument transitions to a Power Save mode of operation then the following voltages are ON—pusher electrode 305, reflectron 306, ion detector 307 and more generally the various Time of Flight mass analyser 304 voltages.

The stability of the power supplies for the Time of Flight mass analyser 304, ion detector 307 and reflectron 306 can affect the mass accuracy of the instrument. The settling time when turning ON or switching polarity on a known conventional instrument is around 20 minutes.

It has been established that if the power supplies are cold or have been left OFF for a prolonged period of time then they may require up to 10 hours to warm up and stabilise. For this reason customers may be prevented from going into a Standby mode of operation which would switch OFF the voltages to the Time of Flight analyser 304 including the reflectron 306 and ion detector 307 power supplies.

On start-up the instrument may move to a Power save mode of operation as quickly as possible as this allows the power supplies the time they need to warm up whilst the instrument is pumping down. As a result, by the time the instrument has reached the required pressure to carry out instrument setup the power supplies will have stabilised thus reducing any concerns relating to mass accuracy.

According to various embodiments in the event of a vacuum failure in the vacuum chamber housing the Time of Flight mass analyser 304 then power may be shut down or turned OFF to all the peripherals or sub-modules e.g. the ion source 300, first ion guide 301, the segmented quadrupole rod set ion guide 302, the transfer optics 303, the pusher electrode 305 high voltage supply, the reflectron 306 high voltage supply and the ion detector 307 high voltage supply. The voltages are primarily all turned OFF for reasons of instrument protection and in particular protecting sensitive components of the Time of Flight mass analyser 307 from high voltage discharge damage.

It will be understood that high voltages may be applied to closely spaced electrodes in the Time of Flight mass analyser 304 on the assumption that the operating pressure will be very low and hence there will be no risk of sparking or electrical discharge effects. Accordingly, in the event of a serious vacuum failure in the vacuum chamber housing the Time of Flight mass analyser 304 then the instrument may remove power or switch power OFF to the following modules or sub-modules: (i) the ion source high voltage supply module; (ii) the first ion guide 301 voltage supply module; (iii) the quadrupole ion guide 302 voltage supply module; (iv) the high voltage pusher electrode 305 supply module; (v) the high voltage reflectron 306 voltage supply module; and (vi) the high voltage detector 307 module. The instrument protection mode of operation is different to a Standby mode of operation wherein electrical power is still supplied to various power supplies or modules or sub-modules. In contrast, in an instrument protection mode of operation power is removed to the various power supply modules by the action of a global circuitry control module. Accordingly, if one of the power supply modules were faulty it would still be unable in a fault condition to turn voltages ON because the module would be denied power by the global circuitry control module.

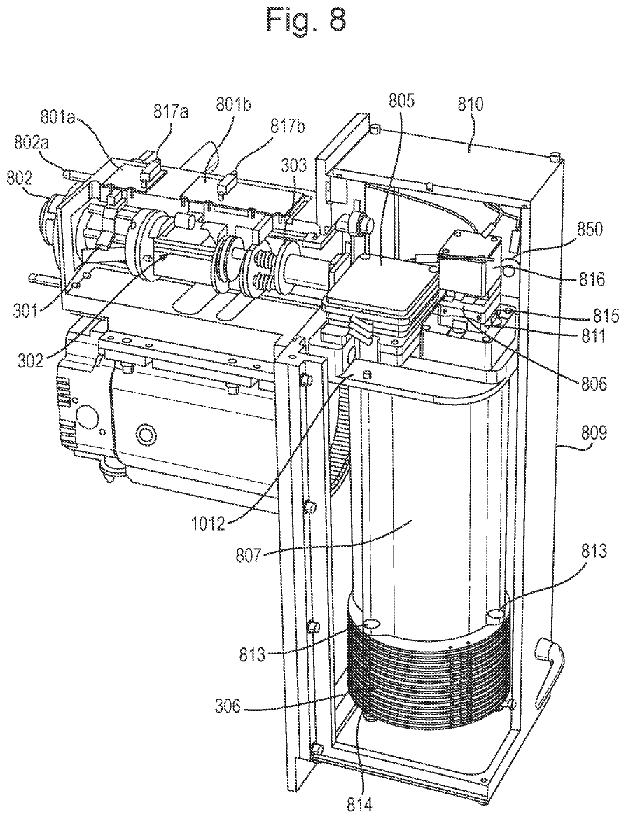

FIG. 8 shows a view of a mass spectrometer 100 according to various embodiments in more detail. The mass spectrometer 100 may comprise a first vacuum PCB interface 801a having a first connector 817a for directly connecting the first vacuum interface PCB 801a to a first local control circuitry module (not shown) and a second vacuum PCB interface 801b having a second connector 817b for directly connecting the second vacuum interface PCB 801b to a second local control circuitry module (not shown).

The mass spectrometer 100 may further comprise a pumping or ion block 802 which is mounted to a pumping block or thermal isolation stage (not viewable in FIG. 8). According to various embodiments one or more dowels or projections 802a may be provided which enable a source enclosure (not shown) to connect to and secure over and house the ion block 802. The source enclosure may serve the purpose of preventing a user from inadvertently coming into contact with any high voltages associated with the Electrospray probe 402. A micro-switch or other form of interlock may be used to detect opening of the source enclosure by a user in order to gain source access whereupon high voltages to the ion source 402 may then be turned OFF for user safety reasons.

Ions are transmitted via an initial or first ion guide 301, which may comprise a conjoined ring ion guide, and then via a segmented quadrupole rod set ion guide 302 to a transfer lens or transfer optics arrangement 303. The transfer optics 303 may be designed in order to provide a highly efficient ion guide and interface into the Time of Flight mass analyser 304 whilst also reducing manufacturing costs.

Ions may be transmitted via the transfer optics 303 so that the ions arrive in a pusher electrode assembly 305. The pusher electrode assembly 305 may also be designed so as to provide high performance whilst at the same time reducing manufacturing costs.

According to various embodiments a cantilevered Time of Flight stack 807 may be provided. The cantilevered arrangement may be used to mount a Time of Flight stack or flight tube 807 and has the advantage of both thermally and electrically isolating the Time of Flight stack or flight tube 807. The cantilevered arrangement represents a significant design departure from conventional instruments and results in substantial improvements in instrument performance.

According to an embodiment an alumina ceramic spacer and a plastic (PEEK) dowel may be used.

According to an embodiment when a lock mass is introduced and the instrument is calibrated then the Time of Flight stack or flight tube 807 will not be subjected to thermal expansion. The cantilevered arrangement according to various embodiments is in contrast to known arrangements wherein both the reflectron 306 and the pusher assembly 305 were mounted to both ends of a side flange. As a result conventional arrangements were subjected to thermal impact.

Ions may be arranged to pass into a flight tube 807 and may be reflected by a reflectron 306 towards an ion detector 811. The output from the ion detector 811 is passed to a pre-amplifier (not shown) and then to an Analogue to Digital Converter (“ADC”) (also not shown). The reflectron 306 is preferably designed so as to provide high performance whilst also reducing manufacturing cost and improving reliability.

As shown in FIG. 8 the various electrode rings and spacers which collectively form the reflectron subassembly may be mounted to a plurality of PEEK support rods 814. The reflectron subassembly may then be clamped to the flight tube 807 using one or more cotter pins 813. As a result, the components of the reflectron subassembly are held under compression which enables the individual electrodes forming the reflectron to be maintained parallel to each other with a high level of precision. According to various embodiments the components may be held under spring loaded compression.

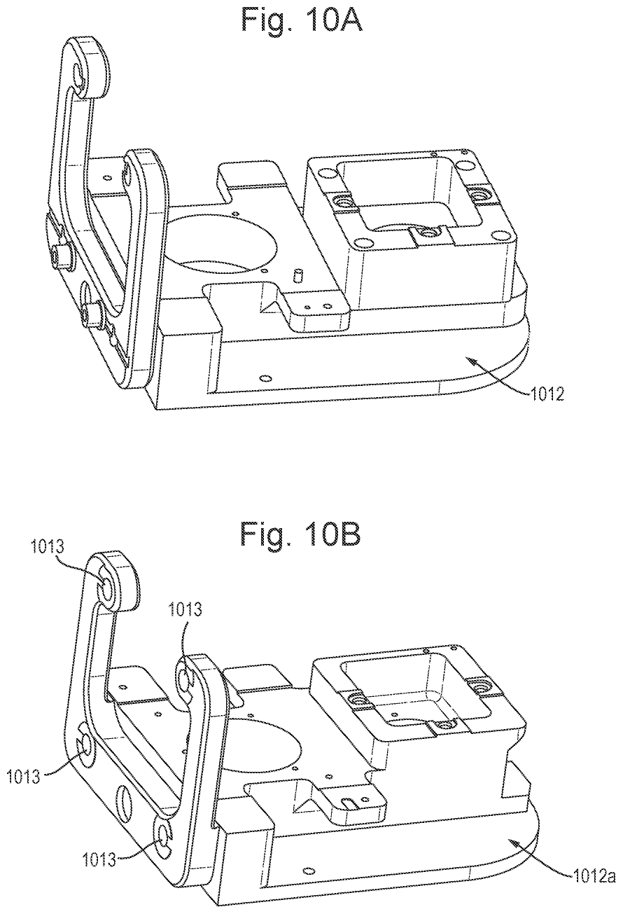

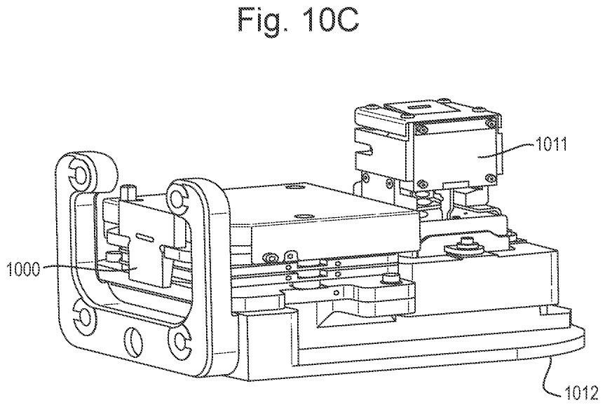

The pusher electrode assembly 305 and the detector electronics or a discrete detector module may be mounted to a common pusher plate assembly 1012. This is described in more detail below with reference to FIGS. 10A-10C.

The Time of Flight mass analyser 304 may have a full length cover 809 which may be readily removed enabling extensive service access. The full length cover 809 may be held in place by a plurality of screws e.g. 5 screws. A service engineer may undo the five screws in order to expose the full length of the time of flight tube 807 and the reflectron 306.

The mass analyser 304 may further comprise a removable lid 810 for quick service access. In particular, the removable lid 810 may provide access to a service engineer so that the service engineer can replace an entrance plate 1000 as shown in FIG. 10C. In particular, the entrance plate 1000 may become contaminated due to ions impacting upon the surface of the entrance plate 1000 resulting in surface charging effects and potentially reducing the efficiency of ion transfer from the transfer optics 303 into a pusher region adjacent the pusher electrode 305.

A SMA (SubMiniature version A) connector or housing 850 is shown but an AC coupler 851 is obscured from view.

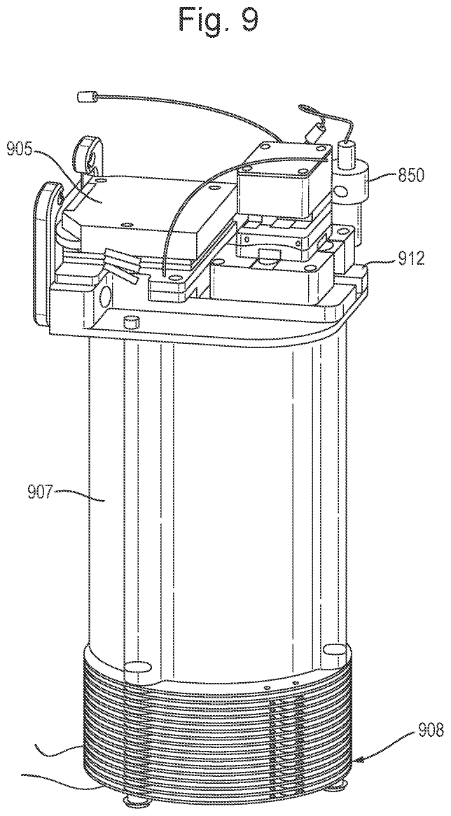

FIG. 9 shows a pusher plate assembly 912, flight tube 907 and reflectron stack 908. A pusher assembly 905 having a pusher shielding cover is also shown. The flight tube 907 may comprise an extruded or plastic flight tube. The reflectron 306 may utilise fewer ceramic components than conventional reflectron assemblies thereby reducing manufacturing cost. According to various embodiments the reflectron 306 may make greater use of PEEK compared with conventional reflectron arrangements.

A SMA (SubMiniature version A) connector or housing 850 is shown but an AC coupler 851 is obscured from view.

According to other embodiments the reflectron 306 may comprise a bonded reflectron. According to another embodiment the reflectron 306 may comprise a metalized ceramic arrangement. According to another embodiment the reflectron 306 may comprise a jigged then bonded arrangement.

According to alternative embodiments instead of stacking, mounting and fixing multiple electrodes or rings, a single bulk piece of an insulating material such as a ceramic may be provided. Conductive metalized regions on the surface may then be provided with electrical connections to these regions so as to define desired electric fields. For example, the inner surface of a single piece of cylindrical shaped ceramic may have multiple parallel metalized conductive rings deposited as an alternative method of providing potential surfaces as a result of stacking multiple individual rings as is known conventionally. The bulk ceramic material provides insulation between the different potentials applied to different surface regions. The alternative arrangement reduces the number of components thereby simplifying the overall design, improving tolerance build up and reducing manufacturing cost. Furthermore, it is contemplated that multiple devices may be constructed this way and may be combined with or without grids or lenses placed in between. For example, according to one embodiment a first grid electrode may be provided, followed by a first ceramic cylindrical element, followed by a second grid electrode followed by a second ceramic cylindrical element.

FIG. 10A shows a pusher plate assembly 1012 comprising three parts according to various embodiments. According to an alternative embodiment a monolithic support plate 1012a may be provided as shown in FIG. 10B. The monolithic support plate 1012a may be made by extrusion. The support plate 1012a may comprise a horse shoe shaped bracket having a plurality (e.g. four) fixing points 1013. According to an embodiment four screws may be used to connect the horse shoe shaped bracket to the housing of the mass spectrometer and enable a cantilevered arrangement to be provided. The bracket may be maintained at a voltage which may be the same as the Time of Flight voltage i.e. 4.5 kV. By way of contrast, the mass spectrometer housing may be maintained at ground voltage i.e. 0V.

FIG. 10C shows a pusher plate assembly 1012 having mounted thereon a pusher electrode assembly and an ion detector assembly 1011. An entrance plate 1000 having an ion entrance slit or aperture is shown.

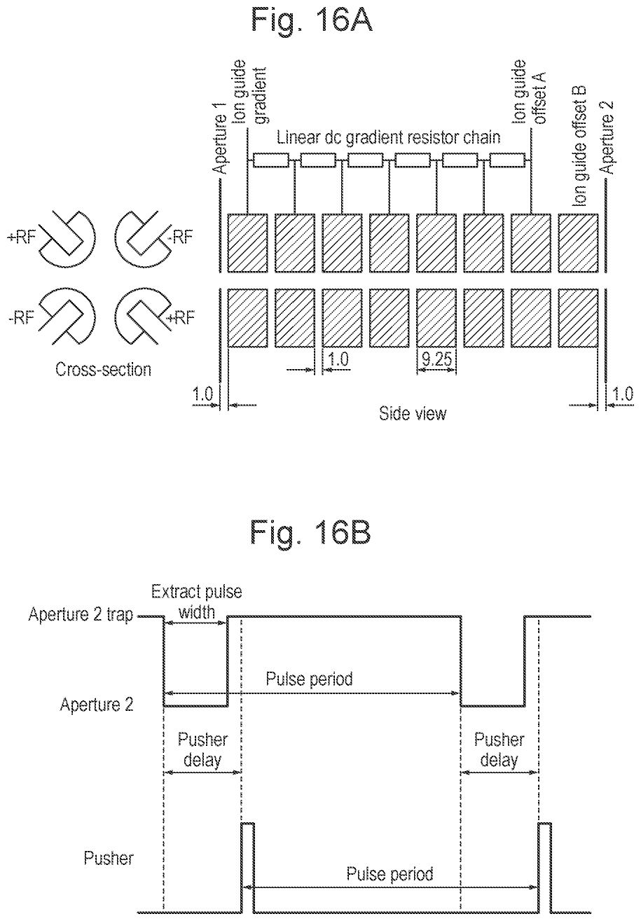

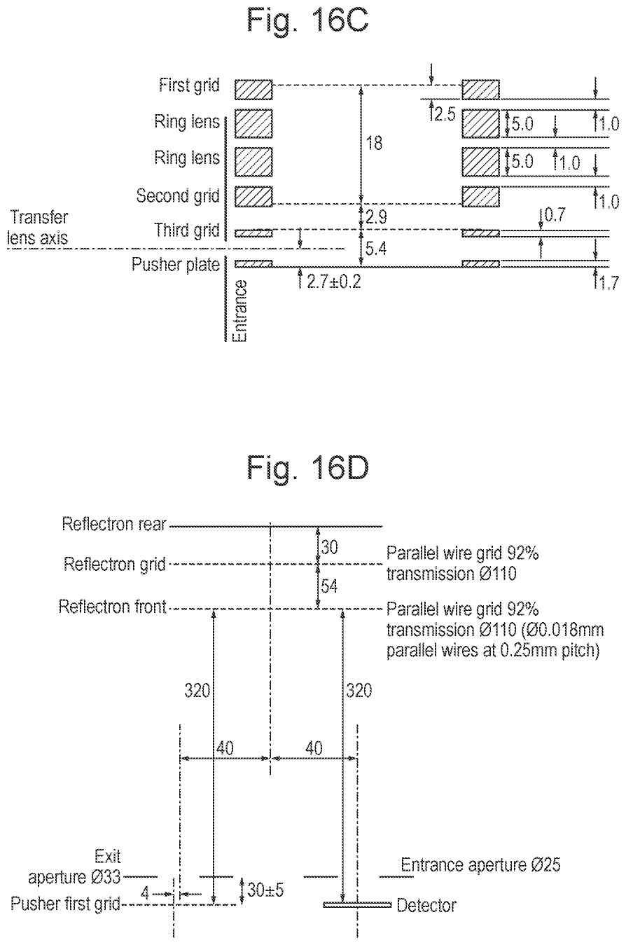

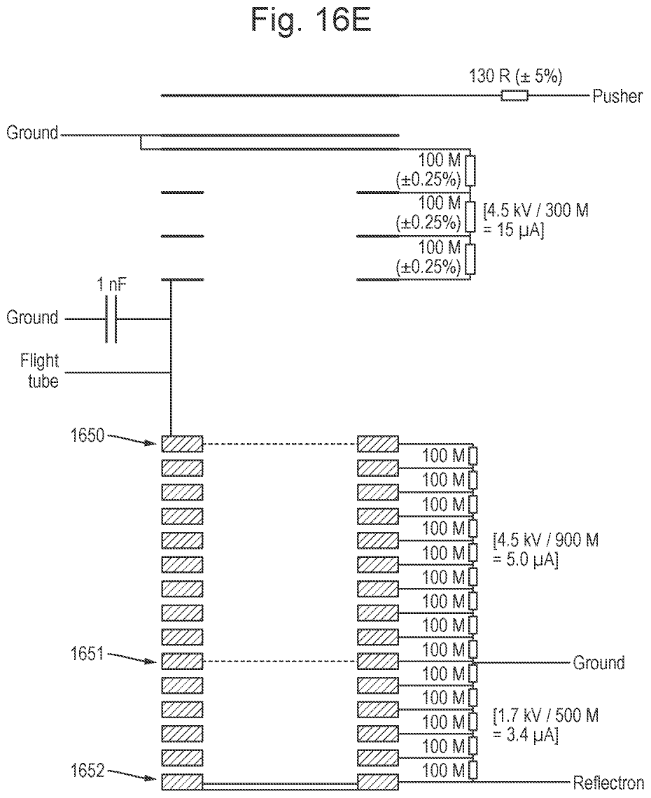

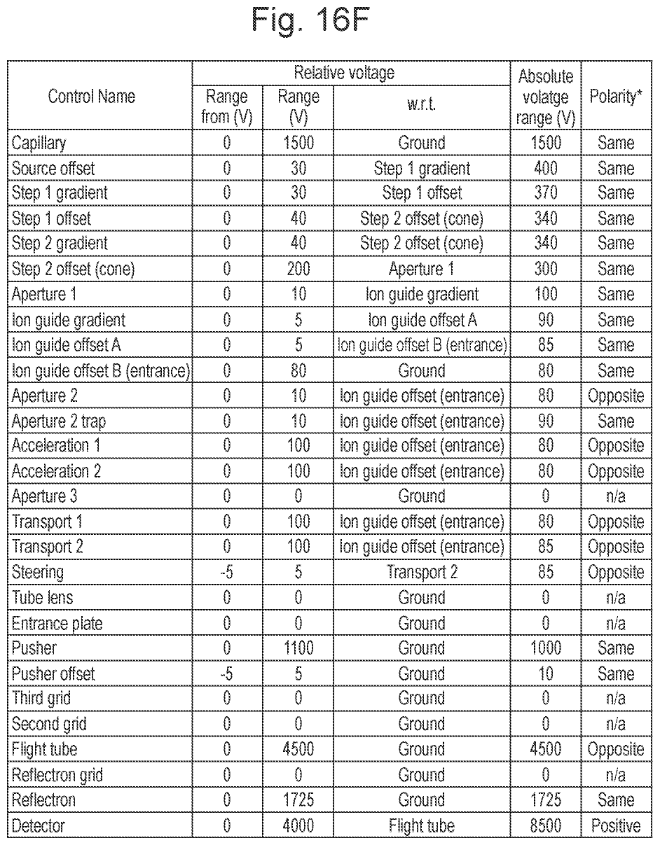

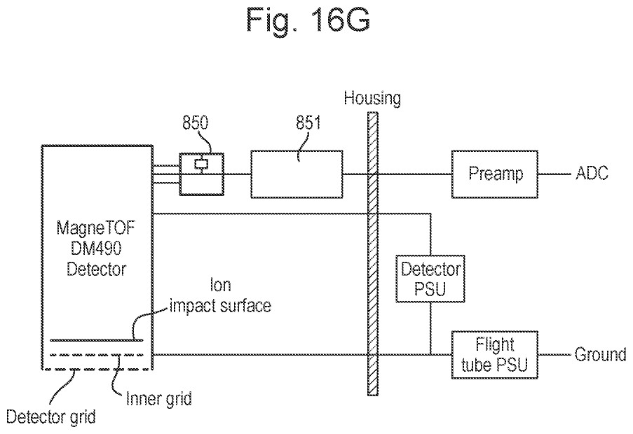

The pusher electrode may comprise a double grid electrode arrangement having a 2.9 mm field free region between a second and third grid electrode as shown in more detail in FIG. 16C.

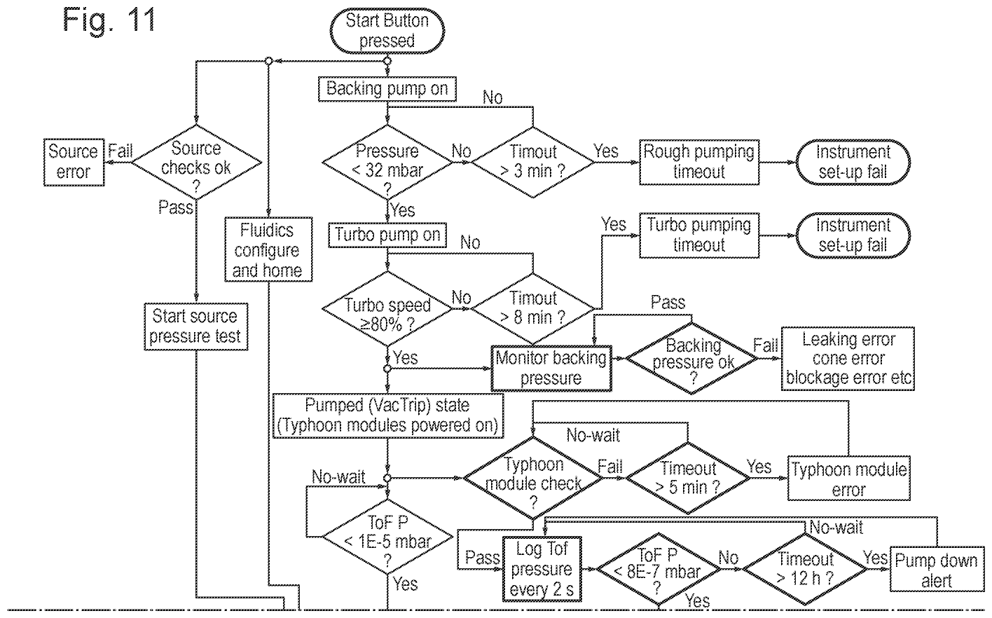

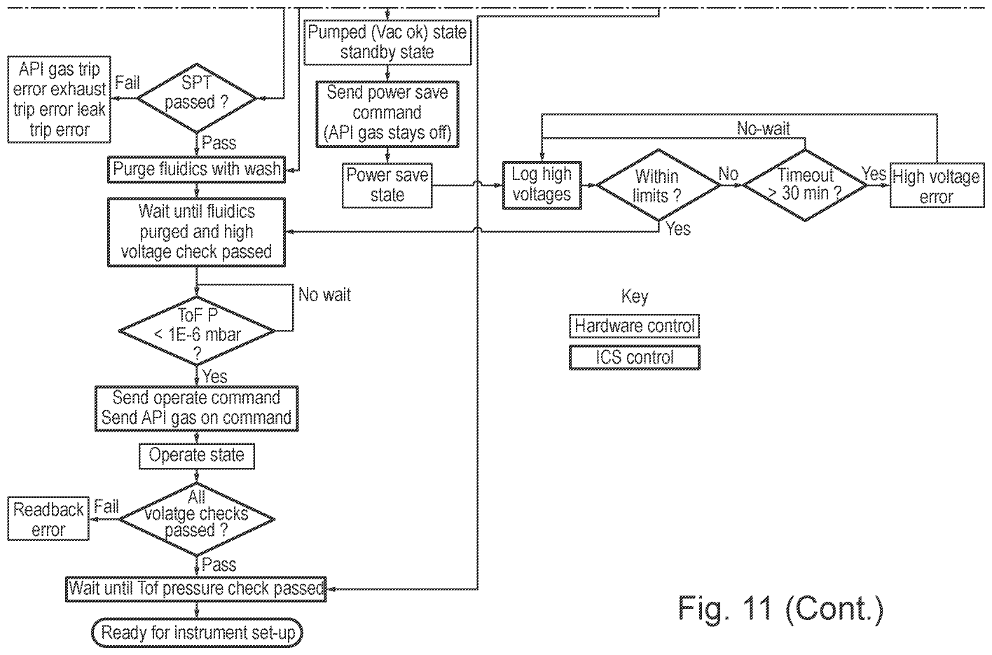

FIG. 11 shows a flow diagram illustrating various processes which may occur once a start button has been pressed.

According to an embodiment when the backing pump is turned ON a check may be made that the pressure is <32 mbar within three minutes of operation. If a pressure of <32 mbar is not achieved or established within three minutes of operation then a rough pumping timeout (amber) warning may be issued.

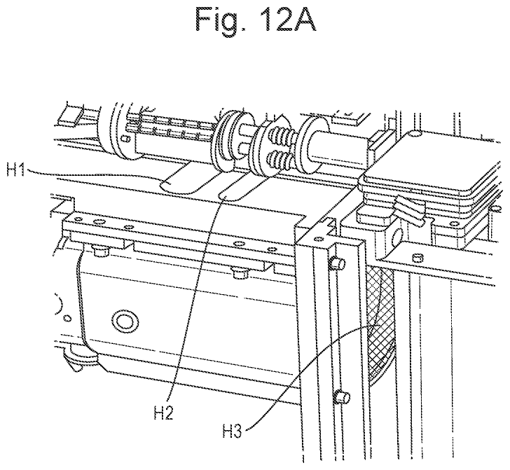

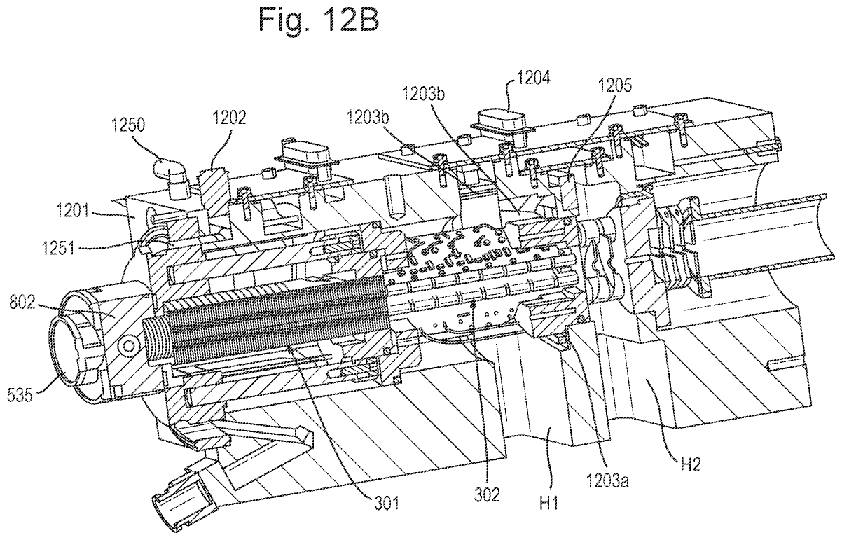

FIG. 12A shows the three different pumping ports of the turbo molecular pump according to various embodiments. The first pumping port H1 may be arranged adjacent the segmented quadrupole rod set 302. The second pumping port H2 may be arranged adjacent a first lens set of the transfer lens arrangement 303. The third pumping port (which may be referred to either as the H port or the H3 port) may be directly connected to Time of Flight mass analyser 304 vacuum chamber.

FIG. 12B shows from a different perspective the first pumping port H1 and the second pumping port H2. The user clamp 535 which is mounted in use to the ion block 802 is shown. The first ion guide 301 and the quadrupole rod set ion guide 302 are also indicated. A nebuliser or cone gas input 1201 is also shown. An access port 1251 is provided for measuring pressure in the source. A direct pressure sensor is provided (not fully shown) for measuring the pressure in the vacuum chamber housing the initial ion guide 301 and which is in fluid communication with the internal volume of the ion block 802. An elbow fitting 1250 and an over pressure relief valve 1202 are also shown.

One or more part-rigid and part-flexible printed circuit boards (“PCBs”) may be provided. According to an embodiment a printed circuit board may be provided which comprises a rigid portion 1203a which is located at the exit of the quadrupole rod set region 302 and which is optionally at least partly arranged perpendicular to the optic axis or direction of ion travel through the quadrupole rod set 302. An upper or other portion of the printed circuit board may comprise a flexible portion 1203b so that the flexible portion 1203b of the printed circuit board has a stepped shape in side profile as shown in FIG. 12B.

According to various embodiments the H1 and H2 pumping ports may comprise EMC splinter shields.

It is also contemplated that the turbo pump may comprise dynamic EMC sealing of the H or H3 port. In particular, an EMC mesh may be provided on the H or H3 port.

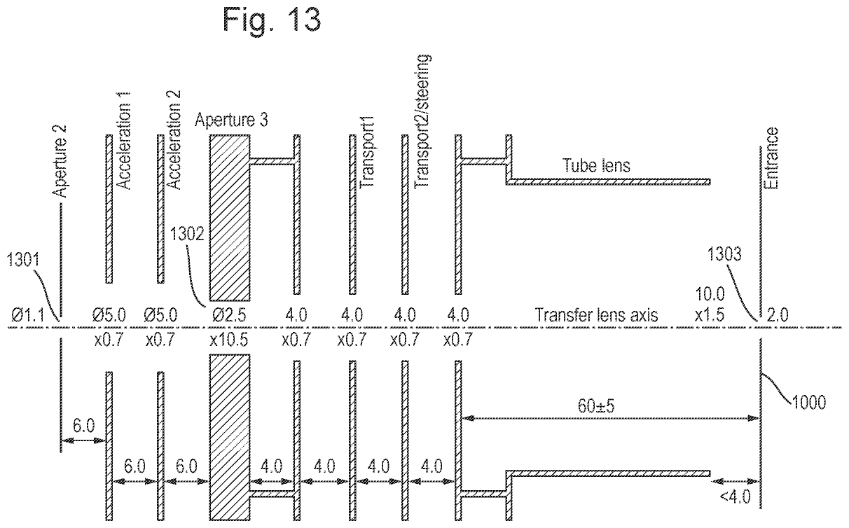

FIG. 13 shows in more detail the transfer lens arrangement 303 and shows a second differential pumping aperture (Aperture #2) 1301 which separates the vacuum chamber housing the segmented quadrupole rod set 302 from first transfer optics which may comprise two acceleration electrodes. The relative spacing of the lens elements, their internal diameters and thicknesses according to an embodiment are shown. However, it should be understood that the relative spacing, size of apertures and thicknesses of the electrodes or lens elements may be varied from the specific values indicated in FIG. 13.

The region upstream of the second aperture (Aperture #2) 1301 may be in fluid communication with the first pumping port H1 of the turbo pump. A third differential pumping aperture (Aperture #3) 1302 may be provided between the first transfer optics and second transfer optics.

The region between the second aperture (Aperture #2) 1301 and the third aperture (Aperture #3) 1302 may be in fluid communication with the second pumping port H2 of the turbo pump.

The second transfer optics which is arranged downstream of the third aperture 1302 may comprises a lens arrangement comprising a first electrode which is electrical connection with the third aperture (Aperture #3) 1302. The lens arrangement may further comprise a second (transport) lens and a third (transport/steering) lens. Ions passing through the second transfer optics then pass through a tube lens before passing through an entrance aperture 1303. Ions passing through the entrance aperture 1303 pass through a slit or entrance plate 1000 into a pusher electrode assembly module.

The lens apertures after Aperture #3 1302 may comprise horizontal slots or plates. Transport 2/steering lens may comprise a pair of half plates.

The entrance plate 1000 may be arranged to be relatively easily removable by a service engineer for cleaning purposes.

One or more of the lens plates or electrodes which form a part of the overall transfer optics 303 may be manufactured by introducing an overcompensation etch of about 5%, as described below. An additional post etch may also be performed. Conventional lens plates or electrodes may have a relatively sharp edge as a result of the manufacturing process. The sharp edges can cause electrical breakdown with conventional arrangements. Lens plates or electrodes which may be fabricated according to various embodiments using an overcompensation etching approach and/or additional post etch may have significantly reduced sharp edges which reduces the potential for electrical breakdown as well as reducing manufacturing cost.

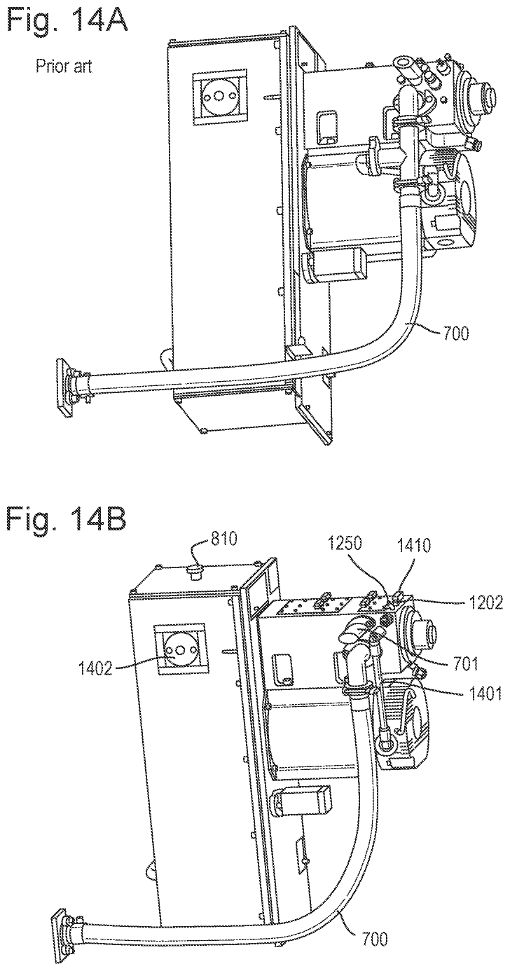

FIG. 14A shows details of a known internal vacuum configuration and FIG. 14B shows details of a new internal vacuum configuration according to various embodiments.

A conventional arrangement is shown in FIG. 14A wherein the connection 700 from the backing pump to the first vacuum chamber of a mass spectrometer makes a T-connection into the turbo pump when backing pressure is reached. However, this requires multiple components so that multiple separate potential leak points are established. Furthermore, the T-connection adds additional manufacturing and maintenance costs.

FIG. 14B shows an embodiment wherein the backing pump 700 is only directly connected to the first vacuum chamber i.e. the T-connection is removed. A separate connection 1401 is provided between the first vacuum chamber and the turbo pump.

A high voltage supply feed through 1402 is shown which provides a high voltage (e.g. 1.1 kV) to the pusher electrode module 305. An upper access panel 810 is also shown. A Pirani pressure gauge 701 is arranged to measure the vacuum pressure in the vacuum chamber housing the first ion guide 301. An elbow gas fitting 1250 is shown through which desolvation/cone gas may be supplied. With reference to FIG. 14B, behind the elbow gas fitting 1250 is shown the over pressure relief valve 1202 and behind the over pressure relief valve 1202 is shown a further elbow fitting which enables gas pressure from the source to be directly measured.

FIG. 15A shows a schematic of the ion block 802 and source or first ion guide 301. According to an embodiment the source or first ion guide 301 may comprise six initial ring electrodes followed by 38-39 open ring or conjoined electrodes. The source or first ion guide 301 may conclude with a further 23 rings. It will be appreciated, however, that the particular ion guide arrangement 301 shown in FIG. 15A may be varied in a number of different ways. In particular, the number of initial ring electrodes (e.g. 6) and/or the number of final stage (e.g. 23) ring electrodes may be varied. Similarly, the number of intermediate open ring or conjoined ring electrodes (e.g. 38-39) may also be varied.

It should be understood that the various dimensions illustrated on FIG. 15A are for illustrative purposes only and are not intended to be limiting. In particular, embodiments are contemplated wherein the sizing of ring and/or conjoined ring electrodes may be different from that shown in FIG. 15A.

A single conjoined ring electrode is also shown in FIG. 15A.

According to various embodiment the initial stage may comprise 0-5, 5-10, 10-15, 15-20, 20-25, 25-30, 30-35, 35-40, 40-45, 45-50 or >50 ring or other shaped electrodes. The intermediate stage may comprise 0-5, 5-10, 10-15, 15-20, 20-25, 25-30, 30-35, 35-40, 40-45, 45-50 or >50 open ring, conjoined ring or other shaped electrodes. The final stage may comprise 0-5, 5-10, 10-15, 15-20, 20-25, 25-30, 30-35, 35-40, 40-45, 45-50 or >50 ring or other shaped electrodes.

The ring electrodes and/or conjoined ring electrodes may have a thickness of 0.5 mm and a spacing of 1.0 mm. However, the electrodes may have other thicknesses and/or different spacings.

Aperture #1 plate may comprise a differential pumping aperture and may have a thickness of 0.5 mm and an orifice diameter of 1.50 mm. Again, these dimensions are illustrative and are not intended to be limiting.

A source or first ion guide RF voltage may be applied to all Step 1 and Step 2 electrodes in a manner as shown in FIG. 15A. The source or first ion guide RF voltage may comprise 200 V peak-to-peak at 1.0 MHz.

Embodiments are contemplated wherein a linear voltage ramp may be applied to Step 2 Offset (cone).

The Step 2 Offset (cone) voltage ramp duration may be made equal to the scan time and the ramp may start at the beginning of a scan. Initial and final values for the Step 2 Offset (cone) ramp may be specified over the complete range of Step 2 Offset (cone).

According to various embodiments a resistor chain as shown in FIG. 15B may be used to produce a linear axial field along the length of Step 1. Adjacent ring electrodes may have opposite phases of RF voltage applied to them.

A resistor chain may also be used to produce a linear axial field along the length of Step 2 as shown in FIG. 15C. Adjacent ring electrodes may have opposite phases of RF voltage applied to them.

Embodiments are contemplated wherein the RF voltage applied to some or substantially all the ring and conjoined ring electrodes forming the first ion guide 301 may be reduced or varied in order to perform a non-mass to charge ratio specific attenuation of the ion beam. For example, as will be appreciated, with a Time of Flight mass analyser 304 the ion detector 307 may suffer from saturation effects if an intense ion beam is received at the pusher electrode 305. Accordingly, the intensity of the ion beam arriving adjacent the pusher electrode 305 can be controlled by varying the RF voltage applied to the electrodes forming the first ion guide 301. Other embodiments are also contemplated wherein the RF voltage applied to the electrodes forming the second ion guide 302 may additionally and/or alternatively be reduced or varied in order to attenuate the ion beam or otherwise control the intensity of the ion beam. In particular, it is desired to control the intensity of the ion beam as received in the pusher electrode 305 region.

FIG. 16A shows in more detail the quadrupole ion guide 302 according to various embodiments. The quadrupole rods may have a diameter of 6.0 mm and may be arranged with an inscribed radius of 2.55 mm. Aperture #2 plate which may comprise a differential pumping aperture may have a thickness of 0.5 mm and an orifice diameter of 1.50 mm. The various dimensions shown in FIG. 16A are intended to be illustrative and non-limiting.

The ion guide RF amplitude applied to the rod electrodes may be controllable over a range from 0 to 800 V peak-to-peak.

The ion guide RF voltage may have a frequency of 1.4 MHz. The RF voltage may be ramped linearly from one value to another and then held at the second value until the end of a scan.

As shown in FIG. 16B, the voltage on the Aperture #2 plate may be pulsed in an Enhanced Duty Cycle mode operation from an Aperture 2 voltage to an Aperture 2 Trap voltage. The extract pulse width may be controllable over the range 1-25 μs. The pulse period may be controllable over the range 22-85 μs. The pusher delay may be controllable over the range 0-85 μs.

FIG. 16C shows in more detail the pusher electrode arrangement. The grid electrodes may comprise Ø 60 parallel wire with 92% transmission (Ø 0.018 mm parallel wires at 0.25 mm pitch). The dimensions shown are intended to be illustrative and non-limiting.

FIG. 16D shows in more detail the Time of Flight geometry. The region between the pusher first grid, reflectron first grid and the detector grid preferably comprises a field free region. The position of the ion detector 307 may be defined by the ion impact surface in the case of a MagneTOF® ion detector or the surface of the front MCP in the case of a MCP detector.

The reflectron ring lenses may be 5 mm high with 1 mm spaces between them. The various dimensions shown in FIG. 16D are intended to be illustrative and non-limiting.

According to various embodiments the parallel wire grids may be aligned with their wires parallel to the instrument axis. It will be understood that the instrument axis runs through the source or first ion guide 301 through to the pusher electrode assembly 305.

A flight tube power supply may be provided which may have an operating output voltage of either +4.5 kV or −4.5 kV depending on the polarity requested.

A reflectron power supply may be provided which may have an operating output voltage ranging from 1625±100 V or −1625±100 V depending on the polarity requested.

FIG. 16E is a schematic of the Time of Flight wiring according to an embodiment. The various resistor values, voltages, currents and capacitances are intended to be illustrative and non-limiting.

According to various embodiments a linear voltage gradient may be maintained along the length of the reflectron 306. In a particular embodiment a reflectron clamp plate may be maintained at the reflectron voltage.

An initial electrode and associated grid 1650 of the reflectron 306 may be maintained at the same voltage or potential as the flight tube 807 and the last electrode of the pusher electrode assembly 305. According to an embodiment the initial electrode and associated grid 1650 of the reflectron 306, the flight tube 807 and the last electrode and associated grid of the pusher electrode assembly 305 may be maintained at a voltage or potential of e.g. 4.5 kV of opposite polarity to the instrument or mode of operation. For example, in positive ion mode the initial electrode and associated grid 1650 of the reflectron 306, the flight tube 807 and the last electrode and associated grid of the pusher electrode assembly 305 may be maintained at a voltage or potential of −4.5 kV.

The second grid electrode 1651 of the reflectron 306 may be maintained at ground or 0V.

The final electrode 1652 of the reflectron 306 may be maintained at a voltage or potential of 1.725 kV of the same polarity as the instrument. For example, in positive ion mode the final electrode 1652 of the reflectron 306 may be maintained at a voltage or potential of +1.725 kV.

It will be understood by those skilled in the art that the reflectron 306 acts to decelerate ions arriving from the time of flight region and to redirect the ions back out of the reflectron 306 in the direction of the ion detector 307.

The voltages and potentials applied to the reflectron 306 according to various embodiments and maintaining the second grid electrode 1651 of the reflectron at ground or 0V is different from the approach adopted in conventional reflectron arrangements.

The ion detector 307 may always be maintained at a positive voltage relative to the flight tube voltage or potential. According to an embodiment the ion detector 307 may be maintained at a +4 kV voltage relative to the flight tube.

Accordingly, in a positive ion mode of operation if the flight tube is maintained at an absolute potential or voltage of −4.5 kV then the detector may be maintained at an absolute potential or voltage of −0.5 kV.

FIG. 16F shows the DC lens supplies according to an embodiment. It will be understood that same polarity means the same as instrument polarity and that Opposite polarity means opposite to instrument polarity. Positive means becomes more positive as the control value is increased and Negative means becomes more negative as the control value is increased. The particular values shown in FIG. 16F are intended to be illustrative and non-limiting.

FIG. 16G shows a schematic of an ion detector arrangement according to various embodiments. The detector grid may form part of the ion detector 307. The ion detector 307 may, for example, comprise a MagneTOF® DM490 ion detector. The inner grid electrode may be held at a voltage of +1320 V with respect to the detector grid and flight tube via a series of Zener diodes and resistors. The ion detector 307 may be connected to a SMA 850 and an AC coupler 851 which may both be provided within or internal to the mass analyser housing or within the mass analyser vacuum chamber. The AC coupler 851 may be connected to an externally located preamp which in turn may be connected to an Analogue to Digital Converter (“ADC”) module.

FIG. 16H shows a potential energy diagram for an instrument according to various embodiments. The potential energy diagram represents an instrument in positive ion mode. In negative ion mode all the polarities are reversed except for the detector polarity. The particular voltages/potentials shown in FIG. 16H are intended to be illustrative and non-limiting.

The instrument may include an Analogue to Digital Converter (“ADC”) which may be operated in peak detecting ADC mode with fixed peak detecting filter coefficients. The ADC may also be run in a Time to Digital Converter (“TDC”) mode of operation wherein all detected ions are assigned unit intensity. The acquisition system may support a scan rate of up to 20 spectra per second. A scan period may range from 40 ms to 1 s. The acquisition system may support a maximum input event rate of 7×10⁶ events per second.

According to various embodiments the instrument may have a mass accuracy of 2-5 ppm may have a chromatographic dynamic range of 10⁴. The instrument may have a high mass resolution with a resolution in the range 10000-15000 for peptide mapping. The mass spectrometer 100 is preferably able to mass analyse intact proteins, glycoforms and lysine variants. The instrument may have a mass to charge ratio range of approx. 8000.

Instrument testing was performed with the instrument fitted with an ESI source 401. Sample was infused at a flow rate of 400 mL/min. Mass range was set to m/z 1000. The instrument was operated in positive ion mode and high resolution mass spectral data was obtained.

According to various embodiments the instrument may have a single analyser tune mode i.e. no sensitivity and resolution modes.

According to various embodiments the resolution of the instrument may be in the range 10000-15000 for high mass or mass to charge ratio ions such as peptide mapping applications. The resolution may be determined by measuring on any singly charged ion having a mass to charge ratio in the range 550-650.

The resolution of the instrument may be around 5500 for low mass ions. The resolution of instrument for low mass ions may be determined by measuring on any singly charged ion having a mass to charge ratio in the range 120-150.

According to various embodiments the instrument may have a sensitivity in MS positive ion mode of approx. 11,000 counts/second. The mass spectrometer 100 may have a mass accuracy of approx. 2-5 ppm

Mass spectral data obtained according to various embodiments was observed as having reduced in-source fragmentation compared with conventional instruments. Adducts are reduced compared with conventional instruments. The mass spectral data also has cleaner valleys (<20%) for mAb glycoforms.

As disclosed in US 2015/0076338 (Micromass), the contents of which are incorporated herein by reference, the instrument according to various embodiment may comprise a plurality of discrete functional modules. The functional modules may comprise, for example, electrical, mechanical, electromechanical or software components. The modules may be individually addressable and may be connected in a network. A scheduler may be arranged to introduce discrete packets of instructions to the network at predetermined times in order to instruct one or more modules to perform various operations. A clock may be associated with the scheduler.

The functional modules may be networked together in a hierarchy such that the highest tier comprises the most time-critical functional modules and the lowest tier comprises functional modules which are the least time time-critical. The scheduler may be connected to the network at the highest tier.

For example, the highest tier may comprise functional modules such as a vacuum control system, a lens control system, a quadrupole control system, an electrospray module, a Time of Flight module and an ion guide module. The lowest tier may comprise functional modules such as power supplies, vacuum pumps and user displays.

The mass spectrometer 100 according to various embodiments may comprise multiple electronics modules for controlling the various elements of the spectrometer. As such, the mass spectrometer may comprise a plurality of discrete functional modules, each operable to perform a predetermined function of the mass spectrometer 100, wherein the functional modules are individually addressable and connected in a network and further comprising a scheduler operable to introduce discrete packets of instructions to the network at predetermined times in order to instruct at least one functional module to perform a predetermined operation.

The mass spectrometer 100 may comprise an electronics module for controlling (and for supplying appropriate voltage to) one or more or each of: (i) the source; (ii) the first ion guide; (iii) the quadrupole ion guide; (iv) the transfer optics; (v) the pusher electrode; (vi) the reflectron; and (vii) the ion detector.

This modular arrangement may allow the mass spectrometer to be reconfigured straightforwardly. For example, one or more different functional elements of the spectrometer may be removed, introduced or changed, and the spectrometer may be configured to automatically recognised which elements are present and to configure itself appropriately.

The instrument may allow for a schedule of packets to be sent onto the network at specific times and intervals during an acquisition. This reduces or alleviates the need for a host computer system with a real time operating system to control aspects of the data acquisition. The use of packets of information sent to individual functional modules also reduces the processing requirements of a host computer.

The modular nature conveniently allows flexibility in the design and/or reconfiguring of a mass spectrometer. According to various embodiments at least some of the functional modules may be common across a range of mass spectrometers and may be integrated into a design with minimal reconfiguration of other modules. Accordingly, when designing a new mass spectrometer, wholesale redesign of all the components and a bespoke control system are not necessary. A mass spectrometer may be assembled by connecting together a plurality of discrete functional modules in a network with a scheduler.

Furthermore, the modular nature of the mass spectrometer 100 according to various embodiments allows for a defective functional module to be replaced easily. A new functional module may simply be connected to the interface. Alternatively, if the control module is physically connected to or integral with the functional module, both can be replaced.

Various features of the instrument according to embodiments will now be described in more detail. It will be appreciated that the instrument may generally comprise any combinations of these features, as appropriate, at least to the extent that they are not mutually exclusive.

### Solvent Bottle Mounting

FIG. 2A shows a front view of a mass spectrometer according to an embodiment. The front panel of the instrument includes a display 202 for displaying to a user information regarding the current operating state of the instrument such as error codes and other status information, as described above. There is also provided a recessed portion including a solvent bottle mounting assembly through which one or more solvent bottles 201 can be connected to the instrument. Because the mounting assembly is provided on the front surface of the instrument, the solvent bottles 201 are highly accessible to the user. Furthermore, because the display 202 is provided adjacently the solvent bottles 201, on the same external face of the instrument, a user is able to easily simultaneously ascertain the current operating status of the instrument (i.e. from the display 202) as well as the state of the solvent bottles 201.

Although FIG. 2A shows a mounting assembly into which (up to) three solvent bottles 201 can be plugged in or otherwise connected it will be appreciated that the instrument may generally be designed able to accommodate fewer, or greater, solvent bottles, as desired.

Conventionally, because solvent bottles 201 typically have a screw top opening, the mass spectrometer is provided with screw mounts so that the solvent bottles can therefore be screwed into place onto the mass spectrometer. However, there are various problems with the conventional arrangement. For instance, because the solvent bottles are screwed into place, it is often the case that when a solvent bottle is mounted on the instrument, the label will end up facing away from the user so that a user may mount a solvent bottle but then be unable to read the label on the bottle so that the user (or a subsequent user) cannot immediately determine which bottles are connected. The user may therefore have to unscrew the bottle to check and then re-mount the bottle.

Thus, according to various embodiments, the conventional screw mounts are replaced with a mounting mechanism that allows the solvent bottles to be pressed into place by a user, i.e. without requiring any screwing. Because the solvent bottles can be simply pressed into place the orientation of the bottles can thus be maintained during the mounting. The user can then ensure that the bottle is installed in the correct orientation, i.e. with the label facing outwardly. Also, it will be appreciated that replacing the conventional screw mounts with the mounting mechanism described herein may allow the instrument to be compatible with other (non-screw top) solvent bottles.

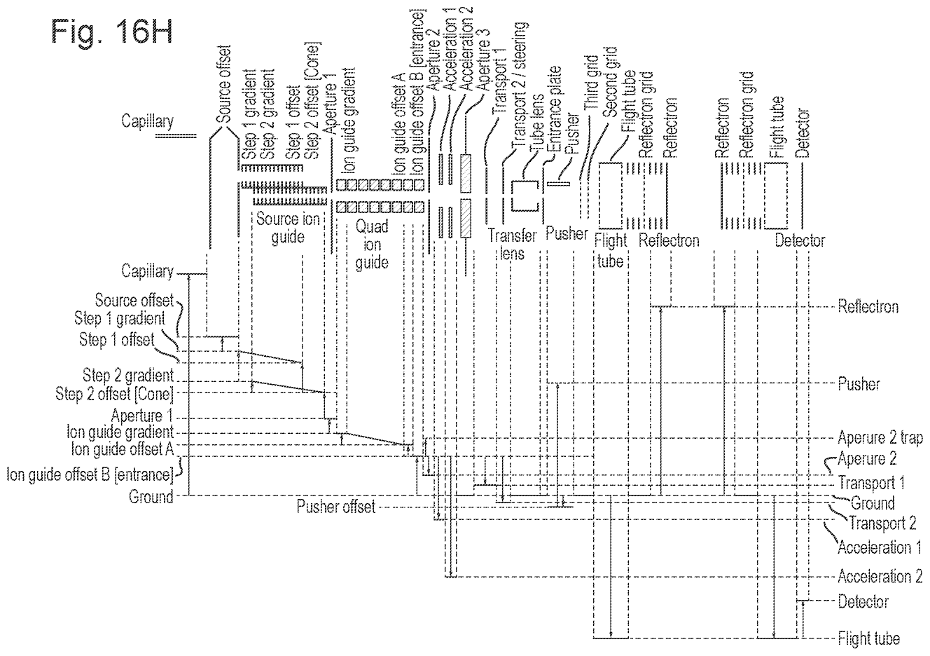

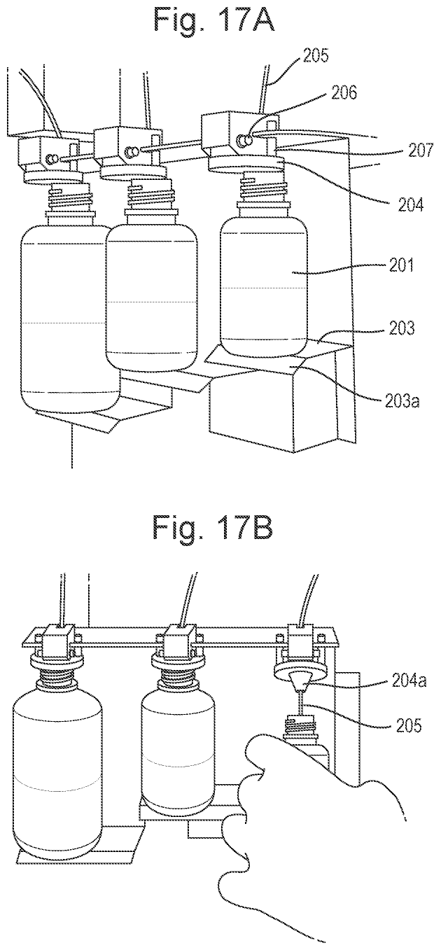

For instance, as shown in FIG. 17A, each of the solvent bottle mounting means may comprise a resilient spring mount.

Particularly, each solvent bottle mounting assembly comprises a sealing element 204 in the form of a suitably resilient (e.g. rubber) disc that acts to provide a substantially airtight seal around the opening of a solvent bottle 201 when the solvent bottle 201 is mounted to the instrument to prevent solvent evaporation. The sealing element 204 is thus shaped and sized suitably in order to seal around the circumference of the bottle opening. In general, the sealing element may have any suitable shape for sealing around the bottle opening. For instance, although the sealing element 204 may comprise a substantially circular disc as illustrated, it will be appreciated that the sealing element 204 may take various other forms, as desired. As best shown in FIG. 17B, the sealing element 204 may also comprise a tapered portion 204a for further facilitating the sealing around the bottle opening. The tapered portion 204a may be designed to fit into the bottle opening and to thereby provide a seal around the interior surface thereof. This may help to provide more effective sealing even when the circumference of the bottle opening is uneven or somehow damaged.

Each solvent bottle mounting assembly is also associated with a solvent line 205 that extends through the respective sealing element 204 of the solvent bottle mounting assembly. Accordingly, when a solvent bottle 201 is mounted in sealing arrangement with a sealing element 204, the respective solvent line 205 then extends into the solvent bottle 201 to allow solvent from the bottle to be transferred through the sealing element 204 to the mass spectrometer. The solvent lines 205 are thus each open at one end so that the solvent lines 205 can be inserted into a solvent bottle mounted onto the instrument and each connected at the other end to a respective solvent port (not shown) of the mass spectrometer. For example, the solvent lines may suitably be connected to one or more solvent ports within the source region of the mass spectrometer for introducing solvent thereto. However, various other arrangements would also be possible, e.g. depending on where it is was desired to introduce solvent.

As shown in FIG. 17A, when a solvent bottle 201 is connected to the mass spectrometer using one of the solvent bottle mounting assemblies, the solvent bottle 201 is generally held in place between the respective sealing element 204 thereof and a suitably spaced backstop 203 against which the base of the bottle can rest.

Each sealing element 204 is also connected to one or more spring 207 that acts to bias the sealing elements 204 onto the opening of the solvent bottle 201. The spring 207 may thus help to hold the solvent bottle in position with a sufficiently air tight seal by pushing the sealing element 204 towards the opening of the solvent bottle. The solvent bottles 201 is thus generally spring-loaded onto the solvent bottle mounting assembly and held in place against the backstop 203 through the elastic force of the one or more spring 207.

In order to mount a solvent bottle 201 to the mass spectrometer, a user may thus push the bottle onto the respective sealing element 204 against the force of the spring 207 in order to fit the solvent bottle 201 onto the mounting assembly in the mounting position where it is then held in place between the sealing element 204 and the backstop 203. The solvent bottle 201 can then be dismounted by pulling the bottle away from the mounting position.

To facilitate the mounting of the solvent bottles, the sealing elements 204 may thus be moveable, or otherwise deformable, so that a solvent bottle 201 can easily be pressed into the mounting position. For example, as shown in FIGS. 17A and 17B, the sealing element 204 may suitably be connected to a hinge 206 to allow the sealing element 204 to pivot between an open position for receiving a solvent bottle to be mounted and a mounting position in which the solvent bottle is mounted in place. In this case, the spring 207 acts to bias the sealing element away from the mounting position. Thus, as best shown in FIG. 17B, in order to mount a solvent bottle 201 onto the mass spectrometer, a user can push a solvent bottle onto and against the sealing element 204 of the desired solvent mounting means to cause the sealing element 204 to pivot into the mounting position.

As shown, the backstop 203 may comprise a chamfered leading edge 203a, or ramp portion, to further facilitate the mounting of the solvent bottles 201 onto the instrument. For instance, a solvent bottle 201 may be mounted to the mass spectrometer by pushing the opening of the bottle against the sealing element 204 at a suitable angle to cause the sealing element 204 to pivot towards the mounting position and the base of the bottle to move over the leading edge 203a and onto the backstop 203 in order to form the desired sealing interference fit.

Another problem with the conventional arrangement is that a user may sometimes put bottles in the wrong location so that solvent is provided to the incorrect solvent line. Typically, different types of solvent are provided in bottles of different sizes, which are usually standard sizes. Thus, in embodiments, the backstop 203 is suitably spaced from the sealing element 204 to accommodate a certain standard size of solvent bottle. A series of backstops 203 may thus be provided each corresponding to a certain size of solvent bottle. In this way, the user can easily tell which size solvent bottle should be installed at which position as a certain size of bottle will only fit in one position. In this way, the possibility for a user to install a bottle in the wrong place is reduced and it can be better ensured that solvent bottles 201 are installed onto the correct solvent line, avoiding potential waste of the solvent and degraded performance, etc. Thus, in some examples, the heights of the backstops 203 may be fixed. However, it is also contemplated that the backstops 203 may be adjustable to accommodate a range of different bottle sizes.

It will be appreciated that various other mounting arrangements for allowing the solvent bottles to be pressed into position are also possible. For instance, one or more resilient clips (not shown) may additionally or alternatively be provided for holding the solvent bottles 201 in place. A solvent bottle 201 may thus be clipped into place, and then sealed by a suitable sealing element. In this case, it will be appreciated that a backstop need not necessarily be provided as the bottles may be held in position by the resilient clip alone (although a backstop may of course still be provided if desired). As another example, instead of providing a hinged or pivotable connection to allow the sealing element to move, the sealing element may be substantially fixed in position but sufficiently flexible to deform when a solvent bottle is pushed against it to allow the solvent bottle to be pressed into the mounting position. Alternatively, instead of providing a hinged or pivotable connection, the sealing element may be able to move in a substantially vertical direction. For instance, the sealing element may be raised to allow solvent bottles to be mounted and then lowered into sealing contact with the opening of the solvent bottle. As yet another example, the sealing element may be rotated or swivelled into the mounting position from a substantially horizontal direction.

Another common problem with conventional arrangements for mounting solvent bottles is that the user may not be able to easily ascertain how much solvent is left within the solvent bottles 201. Thus, in embodiments, the solvent bottles 201 may be illuminated in order to highlight the fill status of the solvent bottles 201 to a user. In general, any suitable light source may be used for illuminating the bottles. However, in embodiments, the solvent bottles 201 may be back lit and in particular an LED light tile may be provided within the recessed portion for illuminating the solvent bottles 201. It will be understood that an LED light tile may provide a more uniform illumination of the bottles. For instance, if a single LED light source was used, it will be appreciated that there is then no single optimal position to install the light source, especially since the solvent itself may act to attenuate the light. The use of an LED light tile to back light the solvent bottles 201 may thus help to provide a clearer indication of the current fill level.

### Turbo Molecular Pumping Ports and Transfer Optics

It will be appreciated that mass spectrometer instruments typically include a number of vacuum chambers that must be maintained at different operating pressures. For instance, it is generally necessary for the analytical stages of a mass spectrometer to be maintained in use at relatively low pressures in order to allow meaningful mass spectra to be acquired. For example, the final stage TOF mass analyser may typically be maintained at a pressure of less than about 10⁻⁵ mbar, or more typically less than about 10⁻⁶ mbar. On the other hand, the source region of the instrument is normally operated at a much higher pressure, and is often open to atmospheric pressures (about 1000 mbar). Thus, it is known to provide differential pumping whereby the pressure is reduced in stages along consecutive vacuum regions along the mass spectrometer. Each vacuum region or chamber may be separated by a suitable differential pumping aperture.

For instance, as described above, FIG. 7A illustrates a vacuum pumping arrangement for a mass spectrometer according to various embodiments wherein a split-flow turbo molecular vacuum pump (commonly referred to as a “turbo” pump) is used to pump the fourth vacuum chamber or fourth differential pumping region, the third vacuum chamber or third differential pumping region, and the second vacuum chamber or second differential pumping region. The turbo molecular vacuum pump may be backed by a rough pump (backing pump) such as a rotary vane vacuum pump or a diaphragm vacuum pump. The rough pump may also be used to pump the first vacuum chamber. FIGS. 12A and 12B show the different pumping ports of the turbo molecular pump.

As described above, the turbo molecular pump is used to provide high vacuum pumping of the analytical regions of the instrument. Turbo molecular pumps cannot typically exhaust to atmospheric pressure and in order for the turbo molecular pump to work efficiently, the turbo molecular pump must also be suitably backed.

One known arrangement for backing the turbo molecular pump is shown in FIG. 14A wherein the backing line is split using a suitable tee connector so that the backing pump is connected both to a first vacuum chamber of the mass spectrometer and also to the backing line of the turbo molecular pump. The backing pump can thus be used to establish a base pressure, and when the base pressure is reached, the turbo molecular pump can then be turned on and used for providing the higher vacuum conditions required for the analytical stages of the instrument downstream of the first vacuum chamber.

That is, in the known arrangement shown in FIG. 14A, the same backing pump is used both for pumping down the first vacuum chamber to the desired base pressure and for backing the turbo molecular pump. It will be appreciated that this arrangement may provide a reduced footprint compared to using a separate backing pump to the turbo molecular pump. However, it will also be appreciated that this arrangement requires relatively many components and connectors so that lots of potential leak points are established. Furthermore, the tee connection may add additional manufacturing and maintenance costs.

Thus, in embodiments, as shown in FIG. 14B, the backing pump is only directly connected to the first vacuum chamber. A separate backing line 1401 is then provided that is connected between the first vacuum chamber and the turbo molecular pump so that the turbo molecular pump can be backed using the first vacuum chamber.

Thus, a base pressure can be established in the first vacuum chamber using the backing pump, similarly as in FIG. 14A, but now the first vacuum chamber is used for backing the turbo molecular pump. In this way, the number of mechanical connections, and possible leak points, can be reduced, thus simplifying the manufacturing costs and maintenance requirements.

### Manufacture of Lens Plate

There are various metallic elements such as lens plates and electrodes located within the mass spectrometer. These elements may require relatively high precision dimensioning. Conventionally such elements are formed using known chemical etching and/or machining processes.

For instance, chemical etching is a subtractive process wherein a substrate to be etched (e.g. a metal plate) is first patterned with a suitably resistive material, and the masked substrate can then be immersed into a bath of corrosive liquid (‘etchant’) in order to selectively etch away any exposed material not covered by the mask. It will be appreciated that the choice of etchant and etching conditions will generally depend on the substrate to be etched. For instance, for etching steel typical etchants may include hydrochloric acid, nitric acid, ferric chloride, Nital (a mixture of nitric acid and ethanol, methanol or methylated spirits). For etching copper, typical etchants may include cupric chloride, ferric chloride, ammonium persulfate, ammonia, nitric acid, hydrochloric acid and hydrogen peroxide, among others. In general, various examples of etching processes are known that may suitably be used depending on the application.

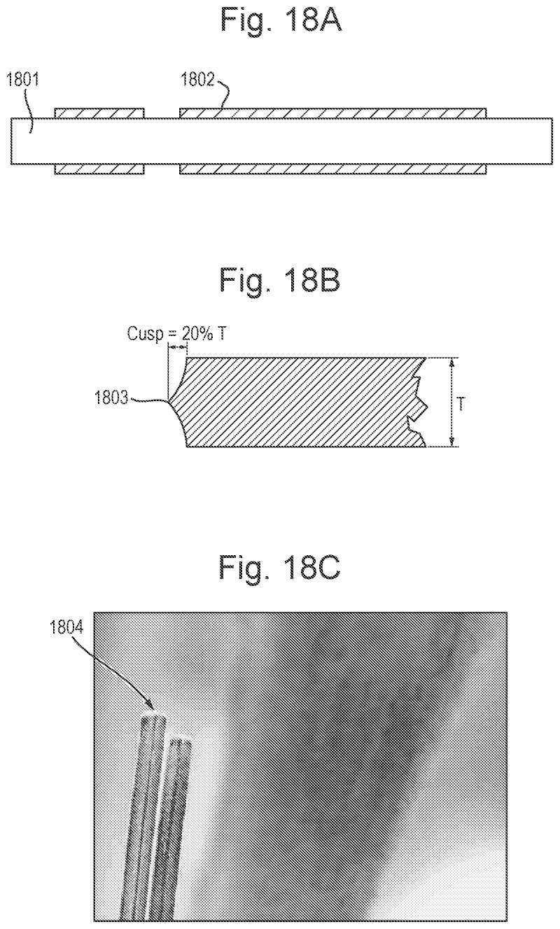

FIG. 18A shows an example of a substrate 1801 that is to be etched with a suitable mask 1802 provided on both faces of the substrate defining a pattern of exposed material. In general, the amount of time that the substrate is immersed in the etchant will determine the depth of the resulting etch. However, chemical etching does not generally provide straight cuts, as there will always be some lateral etch factor. It is known to compensate for the lateral etching. For instance, the size of the mask is selected so that when the chemical etching has cut through the desired thickness T of the substrate the resulting features have the desired lateral dimensions. The appropriate size of mask required to compensate for the lateral etching may thus be known a priori or determined e.g. from previous experiments using the same substrate and etchant (i.e. to determine the lateral etch factor and etch rate, etc.). Thus, for a target shape of lens plate or electrode, the skilled person is generally able to select based on the thickness of the substrate the appropriate size mask and etching conditions (e.g. time) to appropriately compensate for the amount of lateral etching in order to create features having the desired lateral dimensions.

However, as shown in FIG. 18B for example, when a substrate is etched from both sides, a sharp cusp (of up to 20% of the thickness of the substrate) will tend to form along the edges of the substrate between the two faces. The presence of this cusp would create various problems for lens plate or electrodes for use within a mass spectrometer wherein relatively high electric potentials may be applied to the element in use. For instance, if electric potentials were applied to an element having an edge profile like that shown in FIG. 18B, relatively high electric fields will be generated at the cusp potentially resulting in electric breakdown. Also, unwanted magnetic fields may be generated. These effects can generally degrade the performance and robustness of the lens plate or electrode.

Hence, after the chemical etching, it is known to post-machine the chemically etched substrate using a mechanical grinding process to form the final lens plate or electrode with a substantially flat edge profile. However, the fine machining processes that are typically used to grind such edges are generally expensive (˜£50 per plate).

Accordingly, in embodiments, a novel chemical etching process is used for manufacturing the lens plate wherein a first chemical etch is performed using an oversized mask, i.e. a mask with dimensions that are bigger than the dimensions that would normally be needed to compensate for the etching, so that the first chemical etch is effectively ‘overcompensated’. The overcompensated etch allows the substrate to be left in the etchant for longer (than would normally be done, i.e. beyond the point shown in FIG. 18B) so that the etchant is allowed to remove more material and so that the sharpness of the cusp is thereby reduced, resulting in a flatter edge profile. For instance, by introducing an overcompensation etch of between about 1 and 10%, such as about 5%, a relatively smoother edge profile can be provided (beyond this the etchant may start removing too much material resulting in a concave edge profile).

A second or further chemical ‘post-etch’ can then be performed to finish the part and provide a smoother edge profile. For instance, during the post-etch, after the first chemical etch has been performed, the substrate may be passed through the same etching procedure again but at a quicker rate.

FIG. 18C shows an example of a lens plate formed according to embodiments having a substantially smooth edge profile.

In this way, it is therefore possible to reduce the cost of manufacturing a lens plate or electrode whilst still providing a sufficiently smooth edge profile and thus maintaining robustness against electrical breakdown and unwanted magnetic fields.

Thus, it will be appreciated that embodiments of the present disclosure may allow for simplification in the mechanical design of a mass spectrometer in turn resulting in improvements in terms of reduced manufacturing or maintenance costs and/or improved user experience.

Although the present invention has been described with reference to preferred embodiments, it will be understood by those skilled in the art that various changes in form and detail may be made without departing from the scope of the invention as set forth in the accompanying claims.

1. A mass spectrometer comprising:
one or more solvent bottle mounting assembly(ies) for mounting a corresponding one or more solvent bottle(s) to the mass spectrometer, wherein each solvent bottle mounting assembly is associated with a respective solvent line for introducing solvent into the mass spectrometer, and each solvent bottle mounting assembly comprises a sealing element through which the respective solvent line passes,
wherein each solvent bottle mounting assembly is configured so that a user can press a solvent bottle onto the solvent bottle mounting assembly in order to mount the solvent bottle to the mass spectrometer, wherein when a solvent bottle is mounted to the mass spectrometer using a solvent bottle mounting assembly the respective solvent line extends into the solvent bottle to allow solvent to be transferred from the solvent bottle to the mass spectrometer and the sealing element otherwise seals the opening of the solvent bottle.

2. The mass spectrometer of claim 1, wherein each solvent bottle mounting assembly comprises a resilient spring, wherein, when a solvent bottle is mounted to the solvent bottle mounting assembly, the resilient spring acts to bias the sealing element onto the opening of the solvent bottle.

3. The mass spectrometer of claim 1, wherein the sealing element is moveable between an open position ready for receiving a solvent bottle to be mounted and a mounting position in which the solvent bottle can be mounted to the mass spectrometer.

4. The mass spectrometer of claim 3, wherein each solvent bottle mounting assembly comprises a hinge or pivot so that the sealing element can be pivoted between the open position and the mounting position.

5. The mass spectrometer of claim 1, wherein each solvent bottle mounting assembly includes a backstop, wherein when a solvent bottle is mounted onto the solvent bottle mounting assembly, the base of a solvent bottle rests against the backstop so that the solvent bottle is held in place between the sealing element and the backstop.

6. The mass spectrometer of claim 5, comprising a plurality of solvent bottle mounting assemblies each having a respective backstop, and wherein the respective backstops of the plurality of solvent bottle mounting assemblies each have a different height for accommodating a different size of solvent bottle.

7. The mass spectrometer of claim 1, wherein the solvent bottle mounting assembly comprises one or more resilient clips for holding the solvent bottle in place.

8. The mass spectrometer of claim 1, wherein the sealing element comprises a tapered portion for sealing around the inner circumference of the solvent bottle opening.

9. The mass spectrometer of claim 1, wherein the solvent bottle mounting assembly(ies) is arranged within a recess provided on an external surface of the mass spectrometer.

10. The mass spectrometer of claim 1, further comprising a light source for illuminating solvent bottles that have been mounted to the mass spectrometer using the solvent bottle mounting assembly.

11. The mass spectrometer of claim 10, wherein the light source comprises an LED light tile.

12. A mass spectrometry apparatus comprising:
a mass spectrometer comprising a first vacuum chamber and a second vacuum chamber;
a first vacuum pump connected to the first vacuum chamber for pumping the first vacuum chamber to a first pressure; and
a second vacuum pump comprising a vacuum port connected to the second vacuum chamber for pumping the second vacuum chamber;
wherein a backing line for the second vacuum pump is connected to the first vacuum chamber such that the second vacuum pump is backed to the first vacuum chamber.

13. The apparatus of claim 12, wherein the second vacuum pump comprises a turbo molecular vacuum pump, and wherein the second vacuum chamber is an analytical stage of the mass spectrometer.

14. The apparatus of claim 12, wherein the second vacuum pump is configured to maintain the second vacuum chamber in use at a pressure of less than about: (i) 10⁻⁴ mbar, (ii) 10⁻⁵ mbar, or (iii) 10⁻⁶ mbar; and wherein the first vacuum pump is configured to maintain the first vacuum chamber in use at a pressure of between about 10⁻¹ mbar and a pressure of about 10 mbar.

15. The apparatus of claim 12, wherein the first vacuum pump comprises a rotary vane vacuum pump or a diaphragm vacuum pump.

16. The apparatus of claim 12, wherein the mass spectrometer includes one or more intermediate vacuum chambers disposed between the first and second vacuum chambers.

17. The apparatus of claim 16, wherein the second vacuum pump comprises one or more intermediate vacuum ports, and wherein the one or more intermediate vacuum ports of the second vacuum pump are connected to the one or more intermediate vacuum chambers for pumping the intermediate vacuum chambers.

18. A method of manufacturing a lens plate or electrode for use within a mass spectrometer, the method comprising:
providing a substrate for chemical etching, the substrate comprising on both faces a mask that defines a pattern of features for the lens plate or electrode; and
chemically etching the substrate, wherein the chemical etching is performed such that a sharp cusp formed along an edge of the substrate between the faces of the substrate is reduced in order to provide a smoother edge profile.

19. The method of claim 18, comprising performing a first chemical etch and then performing a second or further chemical etch to finish the lens plate or electrode.

20. The method of claim 18, wherein for a lens plate or electrode having features of a target lateral dimension the size of the mask is selected based on the thickness of the substrate so as to allow the chemical etching to remove a sufficient amount of substrate material to reduce the sharp cusp formed along the edge of the substrate and provide a smoother edge profile whilst still providing features having the targeted lateral dimension.
